(19) United States
(12) Patent Application Publication
(10) Pub. No.: US 2008/0288710 A1
(43) Pub. Date: Nov. 20, 2008

(54) Semiconductor Memory Device and Its Control Method

(76) Inventors: Takuji Maeda, Osaka (JP); Shinji Inoue, Osaka (JP); Shoichi Tsujita, Kyoto (JP); Yoshiho Gotoh, Osaka (JP); Jun Ohara, Ehime (JP); Kiminori Matsuno, Osaka (JP); Kazuaki Tamura, Osaka (JP)

Correspondence Address: SMITH PATENT OFFICE, 1901 PENNSYLVANIA AVENUE N W, SUITE 901, WASHINGTON, DC, 20006, US

(21) Appl. No.: 10/586,658

(22) PCT Filed: Jan. 24, 2005
(86) PCT No.: PCT/JP2005/000832

§ 371 Date: Aug. 6, 2008

(30) Foreign Application Priority Data
Jan. 26, 2004 (JP) 2004-017348

(51) Int. Cl. G06F 12/00

(52) U.S. Cl. 711/102; 711/E12.001

(57) ABSTRACT

A card information storage part (119) is provided in a semiconductor memory device (110) to store information of the characteristics of the semiconductor memory device (110). There is also provided a file system interface control part (120) for performing, based on the stored characteristic information, a file access suitable for the characteristics of the semiconductor memory device (110). This allows an access device (100) to perform an optimum file access via the file system interface control part (120) without awareness of the characteristics of the semiconductor memory device (110).

### TECHNICAL FIELD

The present invention relates to a semiconductor memory device for managing data stored in a nonvolatile memory by a file system and a control method of the semiconductor memory device.

### BACKGROUND ART

To record digital data such as music contents and video data, there are various recording media including magnetic disks, optical disks, magneto-optical disks and semiconductor memory devices. The semiconductor memory device is, for example, shaped like a card and uses a semiconductor nonvolatile memory such as a flash ROM as a recording device. Although a semiconductor memory card will be described hereinafter, the present invention can be also applied to a semiconductor memory device having the other shapes. Since the semiconductor memory card can achieve downsizing of the recording media, it has been rapidly widespread mainly in small-sized mobile equipment such as digital still cameras and mobile phone terminals.

Data stored in the semiconductor memory card are managed by a file system and a user can easily handle the stored data as a file. File systems conventionally used include a FAT file system (refer to Non-patent document 1). In addition, there is a UDF file system (Universal Disk Format) (refer to Non-patent document 2) and further there is an NTFS file system (New Technology File System). The semiconductor memory card in which data are managed by these file systems can share a file between apparatuses capable of interpreting the same file system. For this reason, data can be exchanged between the apparatuses.

According to the file systems, an information recording area for recording data is managed by dividing the area into sectors as minimum access units and cluster as a set of the sectors and one or more clusters is managed as a file. An area in which file data is stored is allocated from a free area in the units of clusters and data in 1 file is not necessarily stored in a continuous area. Since a seek operation occurs during reading and writing when file data that is not stored in the continuous area is read or written. There occurs a problem that the reading and writing speed is lowered as compared to the case of file data stored in the continuous area.

As a conventional method for solving the problem, a method for controlling data writing so that data for 1 page of a manuscript is stored in the continuous area in an image processing device is proposed, for example, in Patent document 1. The conventional method ensures that data reading processing can finish within predetermined processing time at data writing by writing data in the continuous area having a fixed length at the data writing.

Patent document 1: Unexamined Patent Publication No. 2002-29101.
Non-patent document 1: ISO/IEC9293, “Information technology-Volume and file structure of disk cartridges for information”, 1994.
Non-patent document 2: OSTA Universal Disk Formal Specification Revision 1. 50, 1997.

### DISCLOSURE OF INVENTION

### Problems to be Solved by the Invention

However, the above-mentioned conventional art has a following problem. According to the conventional control method, data size for 1 page of a manuscript as a processing unit of the image processing device is used as a unit of the continuous area. That is, the unit of the continuous area is determined based on the size suitable for data dealt by an application. This method is effective for the recording medium in which no difference in writing rate occurs depending on the difference in writing unit to the recording medium. However, in the semiconductor memory card, the writing unit greatly affects writing rate and the relationship between the writing unit and writing rate varies depending on properties and managing method of the semiconductor memory to be used. Thus, an optimum access method for all semiconductor memory cards cannot be unique and even when the data size is fixed as in a conventional example, it is impossible to make fast access to all semiconductor memory cards.

In consideration of the above-mentioned problem, an object of the present invention is that an access device can achieve optimum file access regardless of properties of the semiconductor memory card by storing information on the properties of the semiconductor memory card in the semiconductor memory card and providing a file system interface controller that makes file access suitable for the properties of the semiconductor memory card on the basis of the information.

### Means to Solve the Problems

A semiconductor memory device according to the present invention comprises: a nonvolatile memory that consists of a plurality of sectors, a certain number of continuous sectors of which are grouped as a block of a minimum unit for data erase, and writes or reads data transmitted from an external access device; a memory controller for controlling erase, writing and reading of data to said nonvolatile memory when a command containing a control signal is input from said access device; a device information storage part for storing device information concerning physical properties of the semiconductor memory device containing erase block size of said nonvolatile memory; and a file system interface controller for performing file access processing to said nonvolatile memory on the basis of the device information stored in said device information storage part.

A control method of a semiconductor memory device according to the present invention stores device information in advance on physical properties of the semiconductor memory device containing erase block size of said nonvolatile memory in a device information storage part, accepts a command containing a control signal from an external access device, performs file access processing to said nonvolatile memory on the basis of the device information stored in said device information storage part by the file system interface controller and performs erase, writing and reading of data to said nonvolatile memory on the basis of the accepted command in the semiconductor memory device having a nonvolatile memory that consists of a plurality of sectors, and that a certain number of continuous sectors of which are grouped as a block of a minimum unit for data erase.

### Effectiveness of the Invention

According to the present invention, in the semiconductor memory device in which the stored data is managed by the file system, by providing a memory device information storage part that stores information on properties of the semiconductor memory device and a file system interface controller that make file access suitable for the properties of the semiconductor memory device on the basis of the memory device information, the access device can perform optimum file access without taking into account of the properties of the semiconductor memory device.

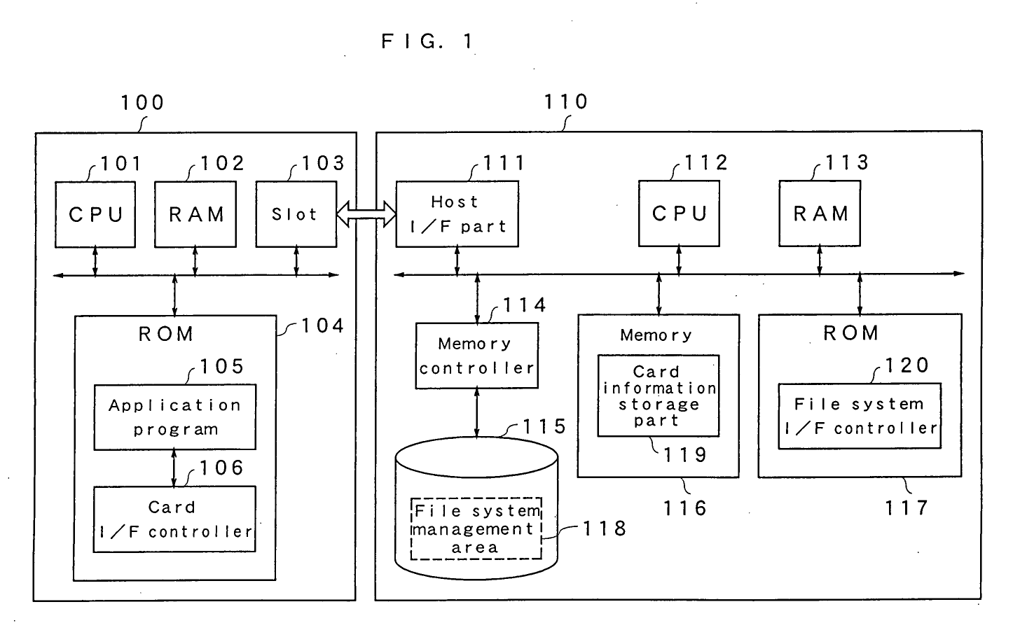

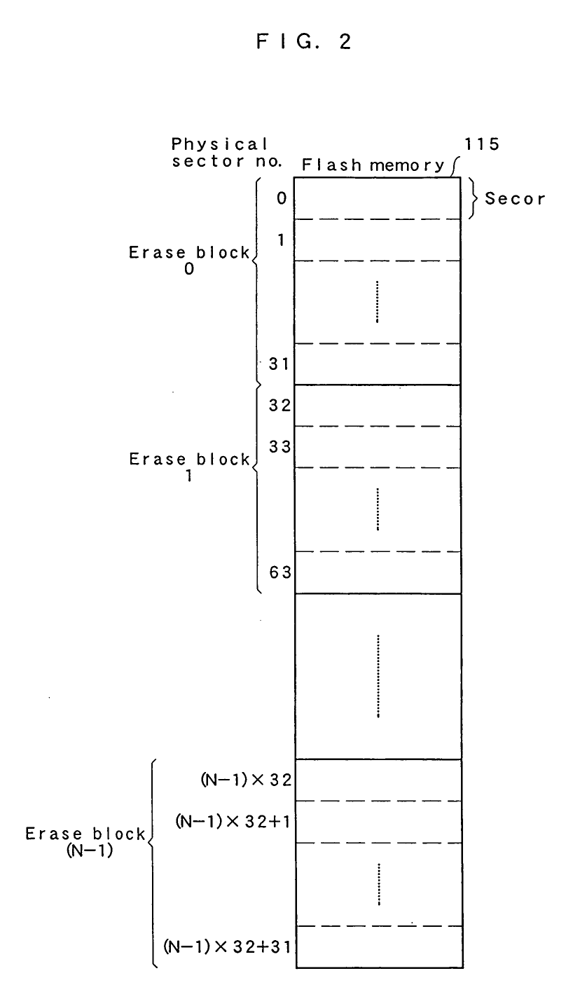

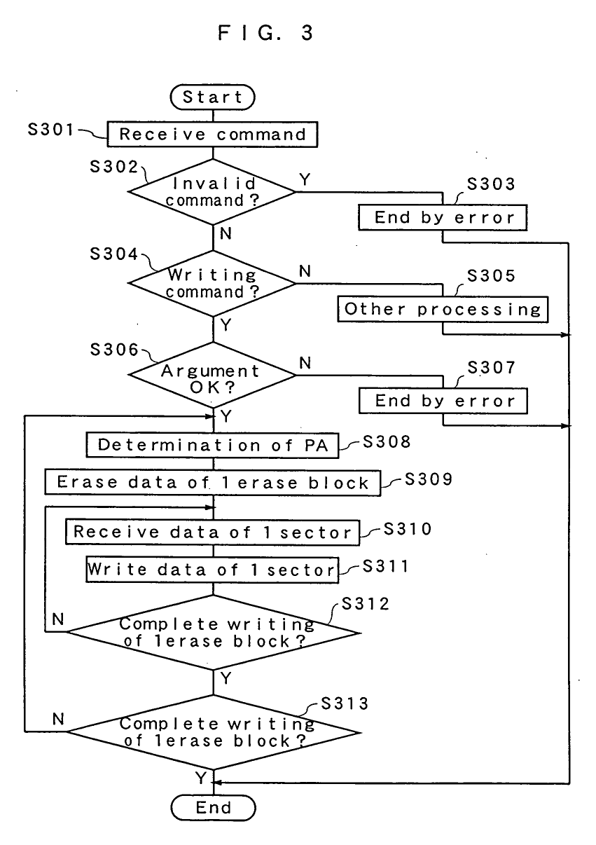

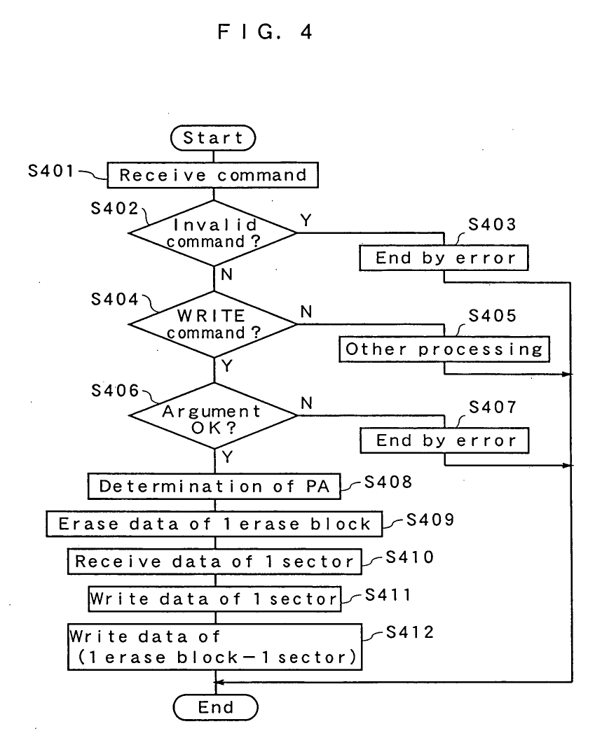

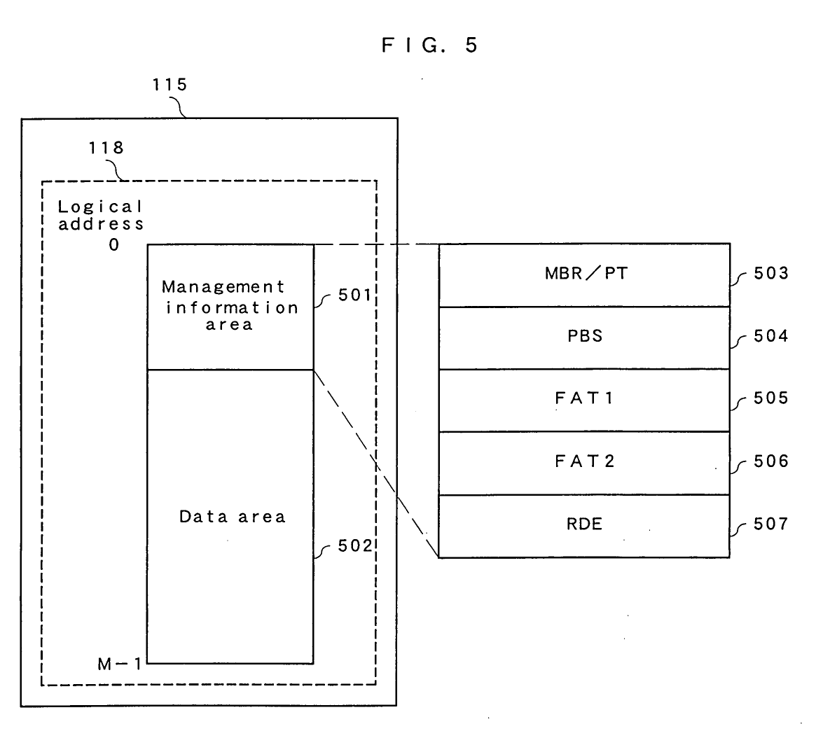

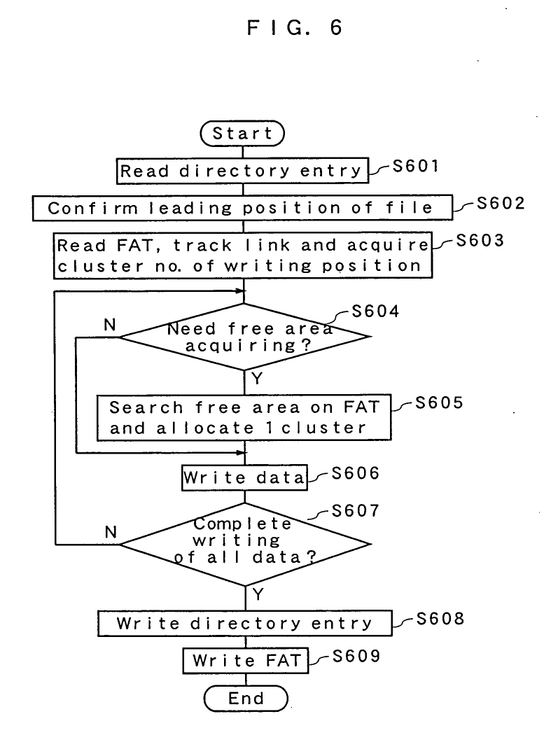

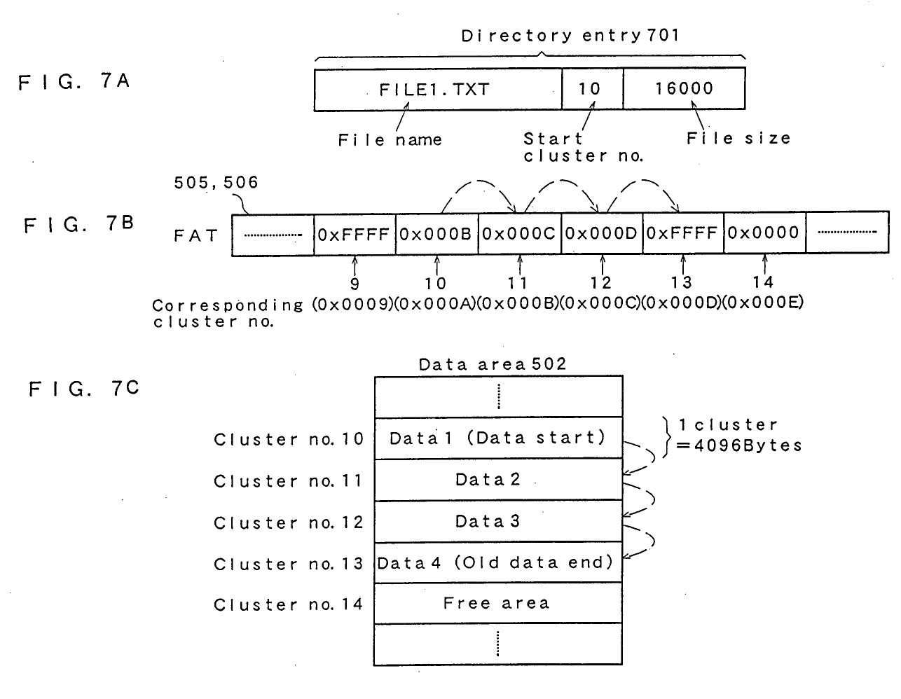

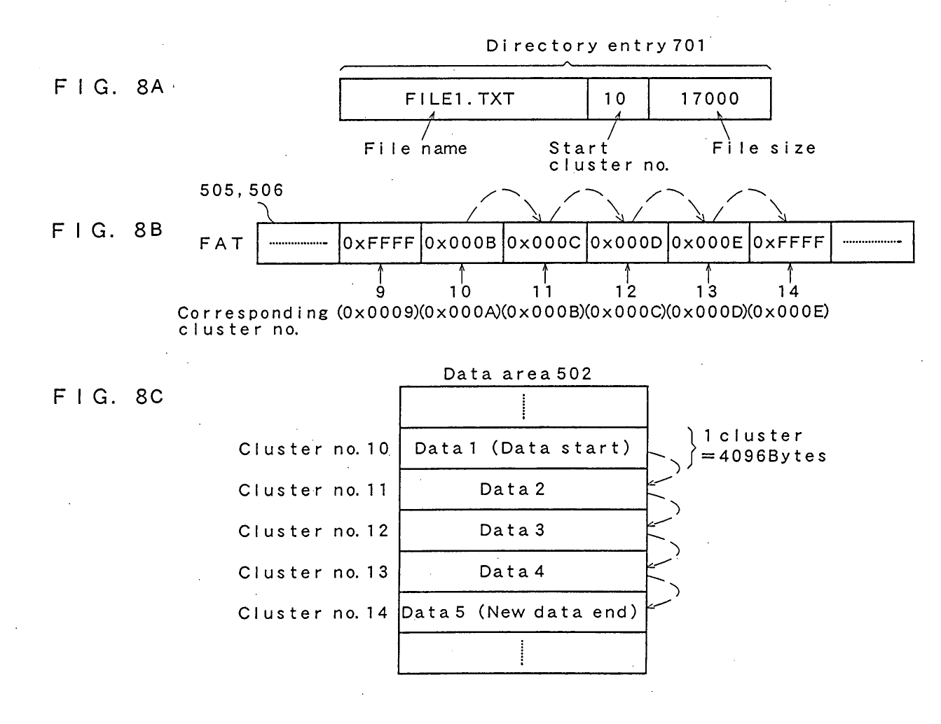

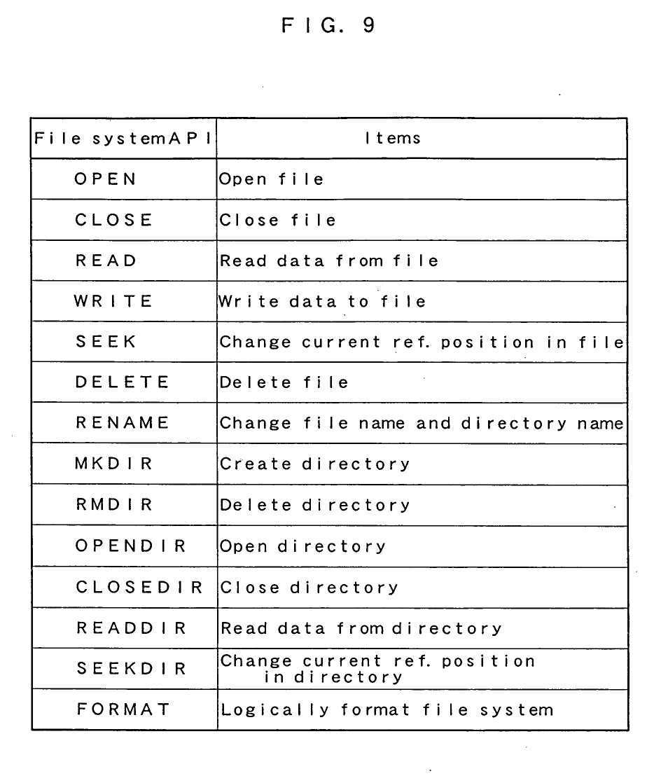

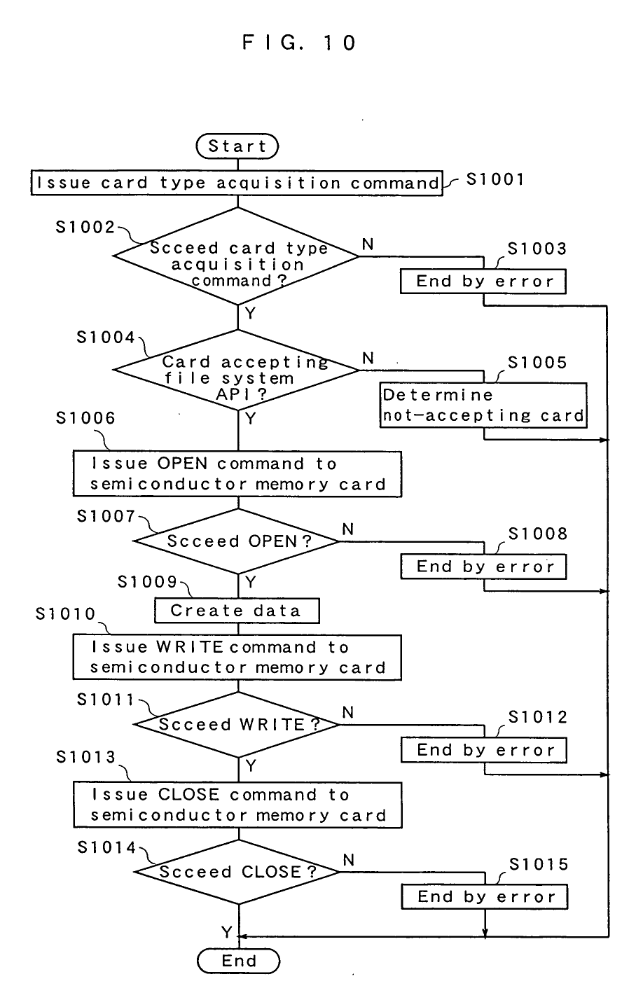

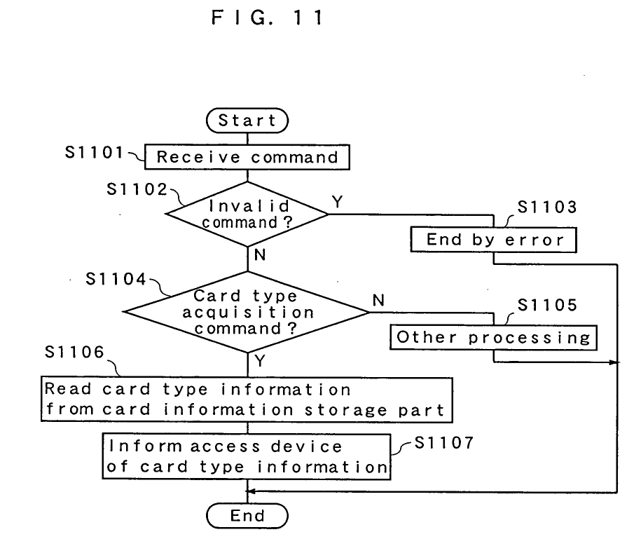

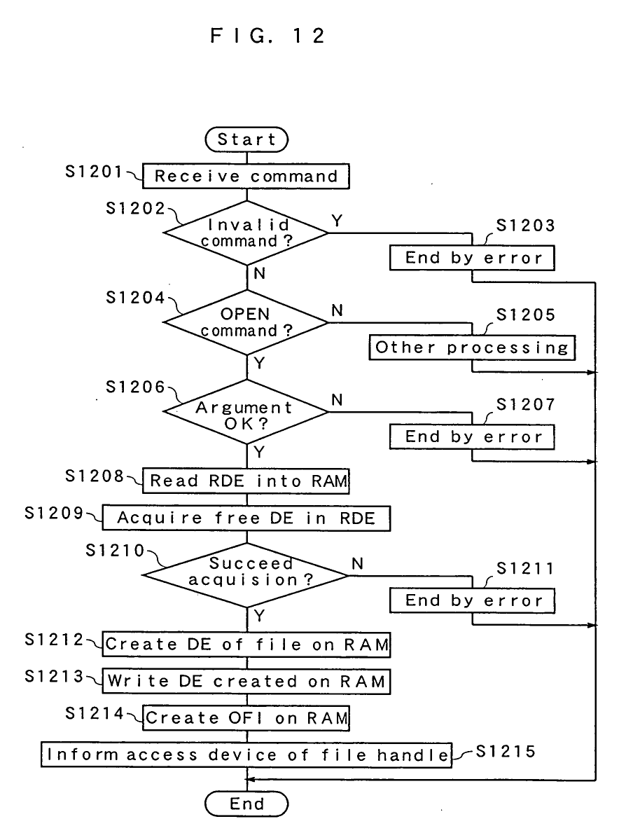

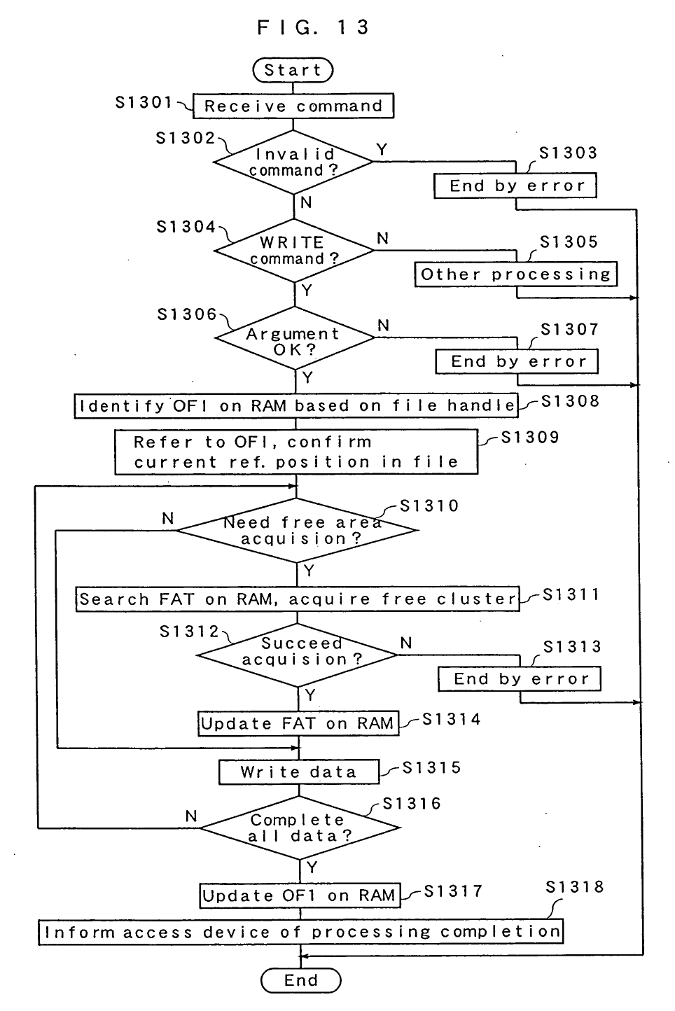

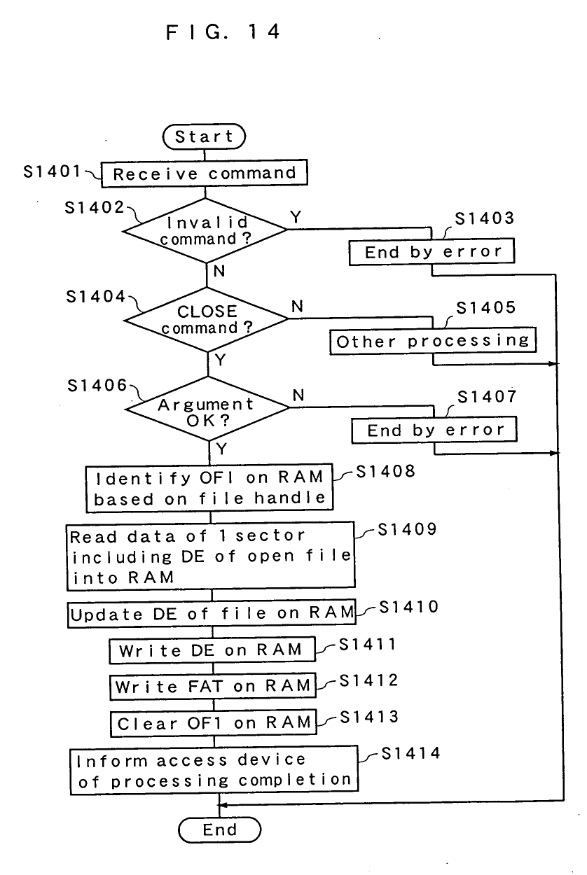

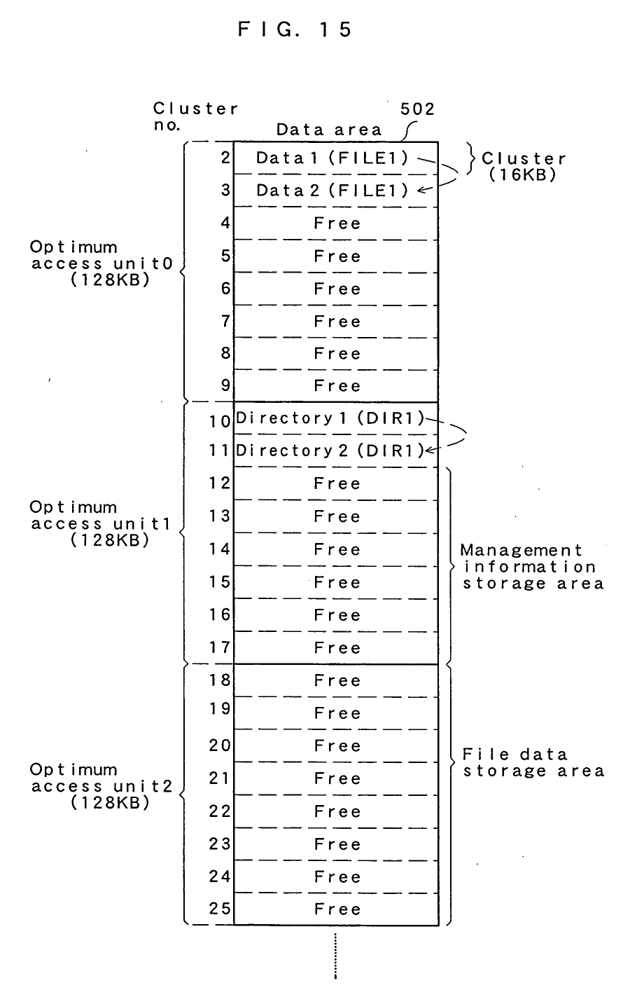

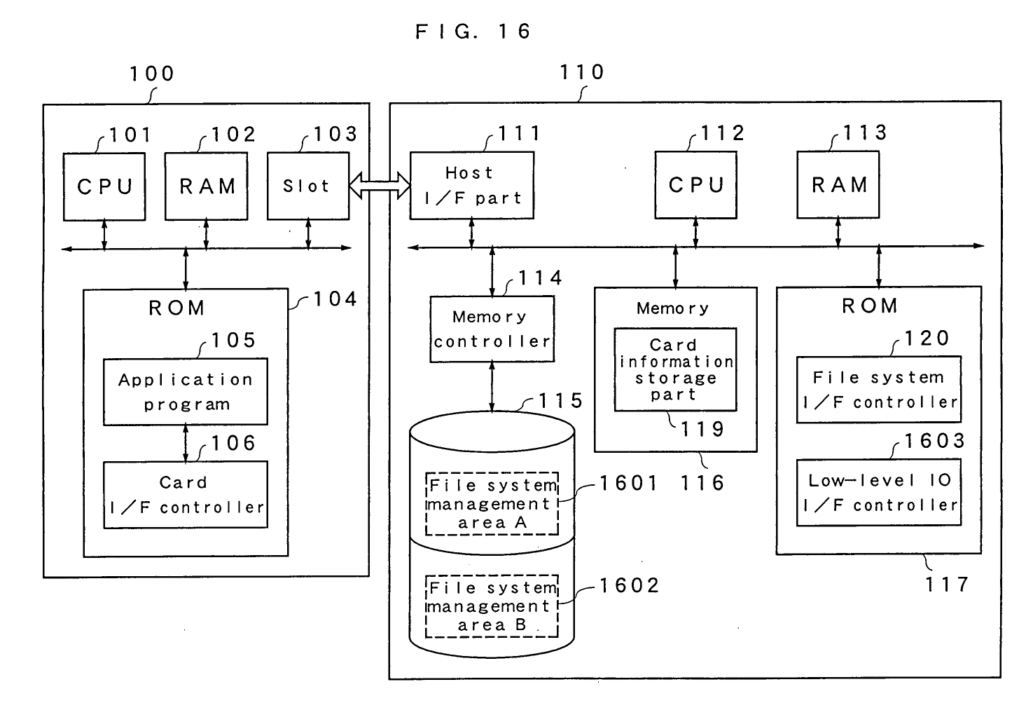

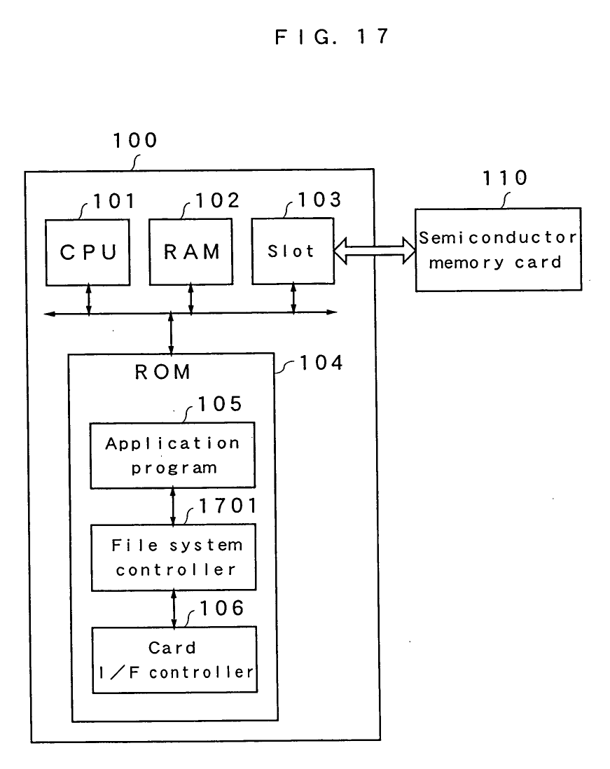

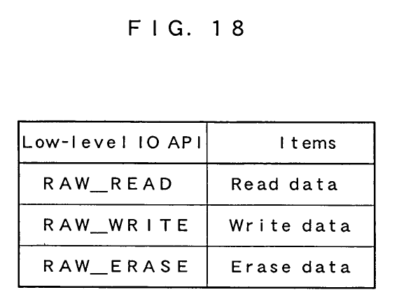

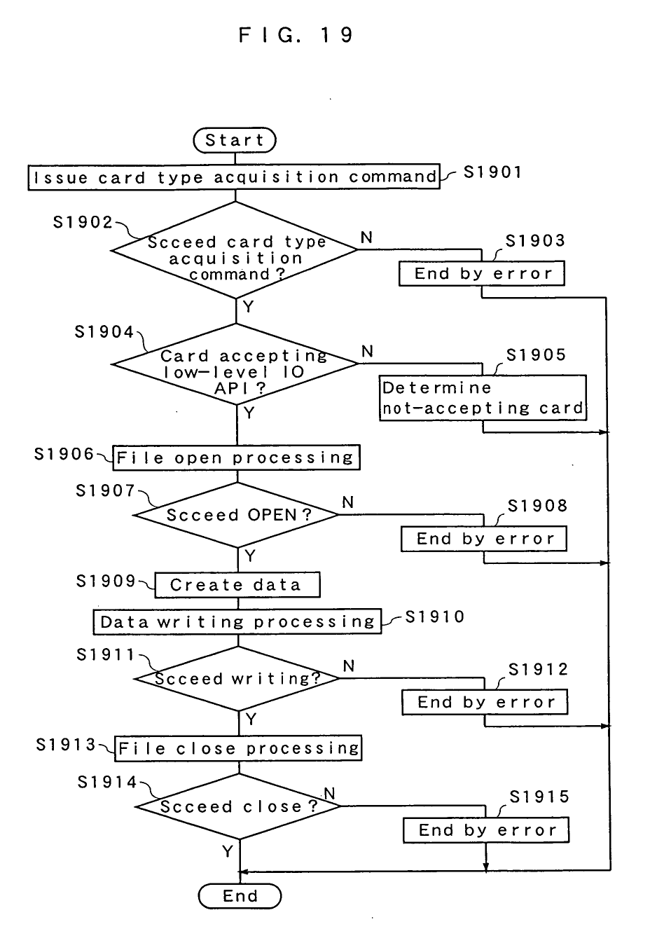

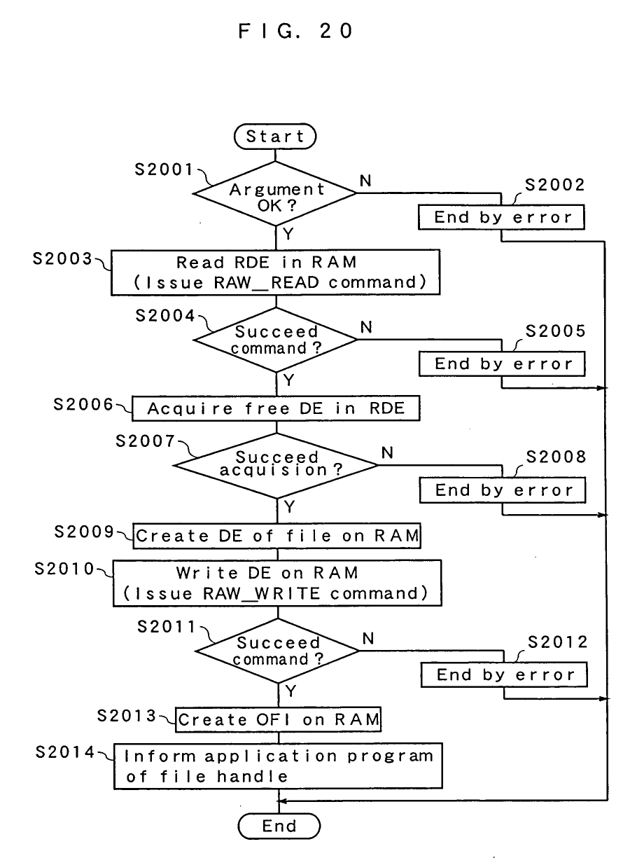

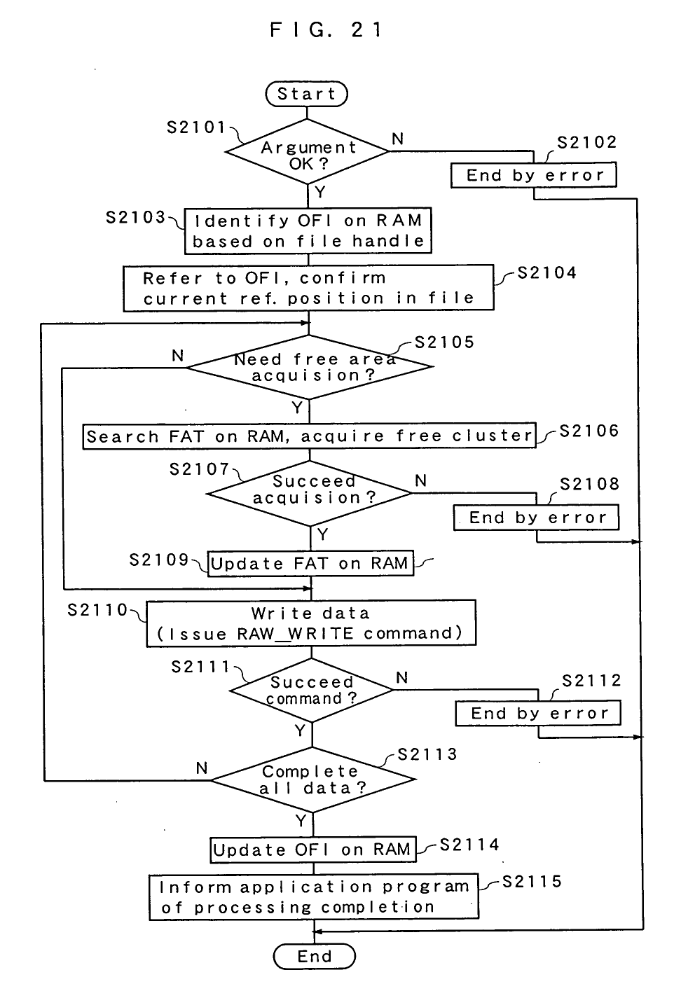

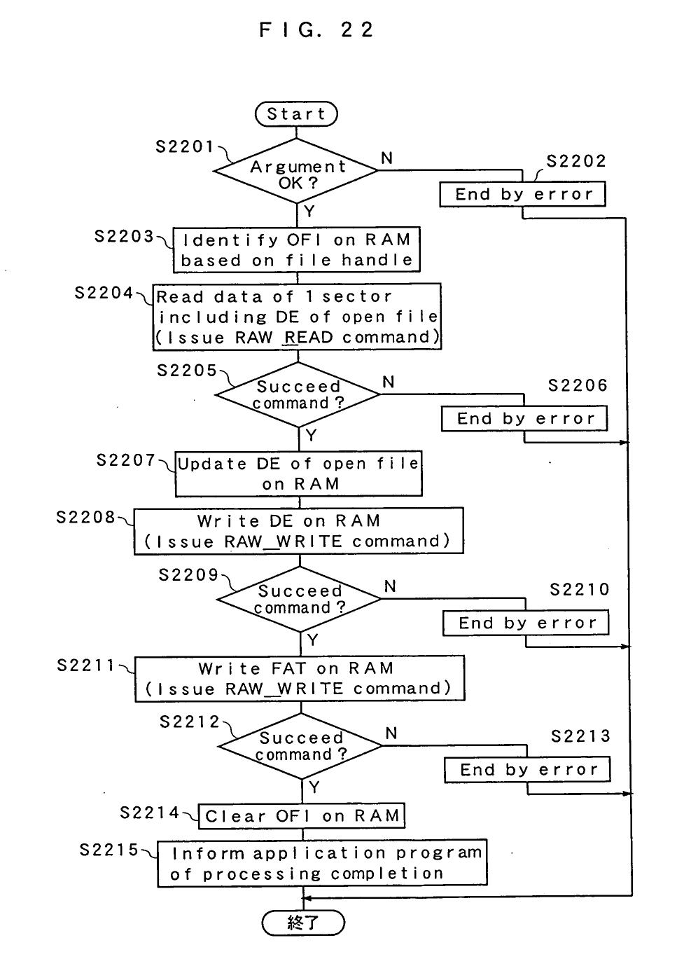

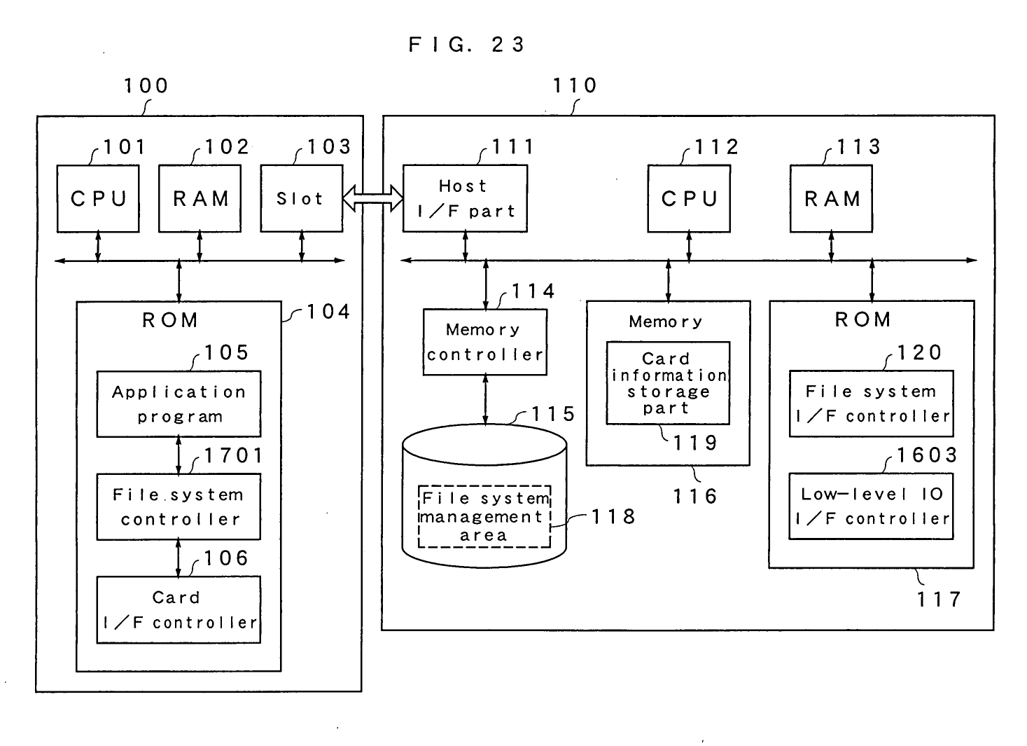

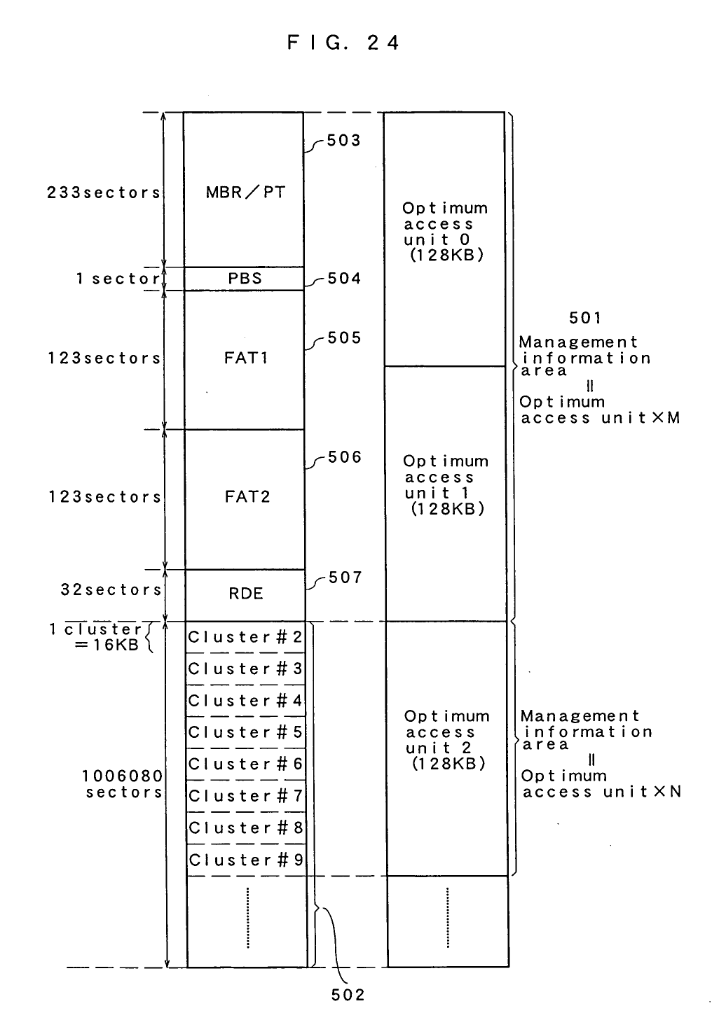

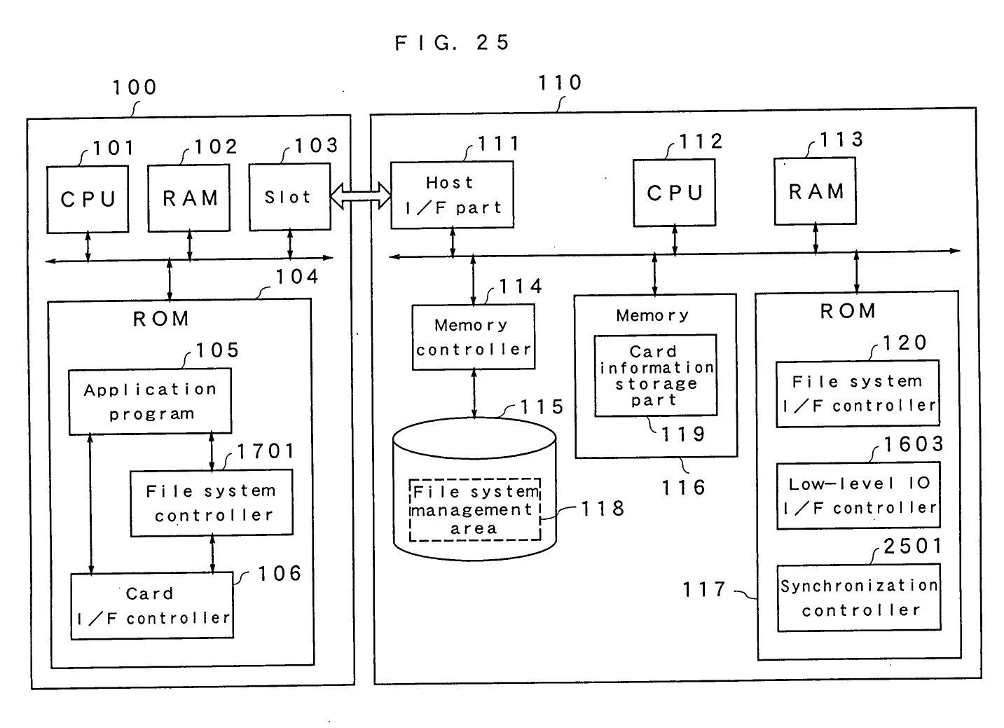

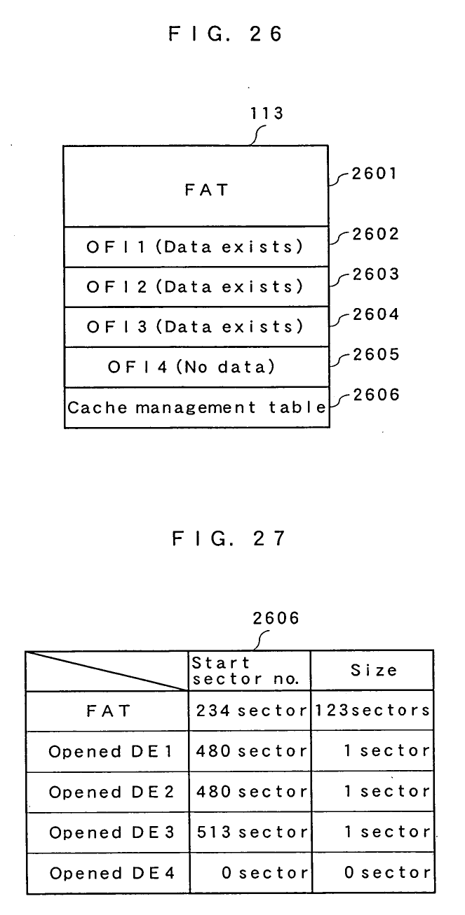

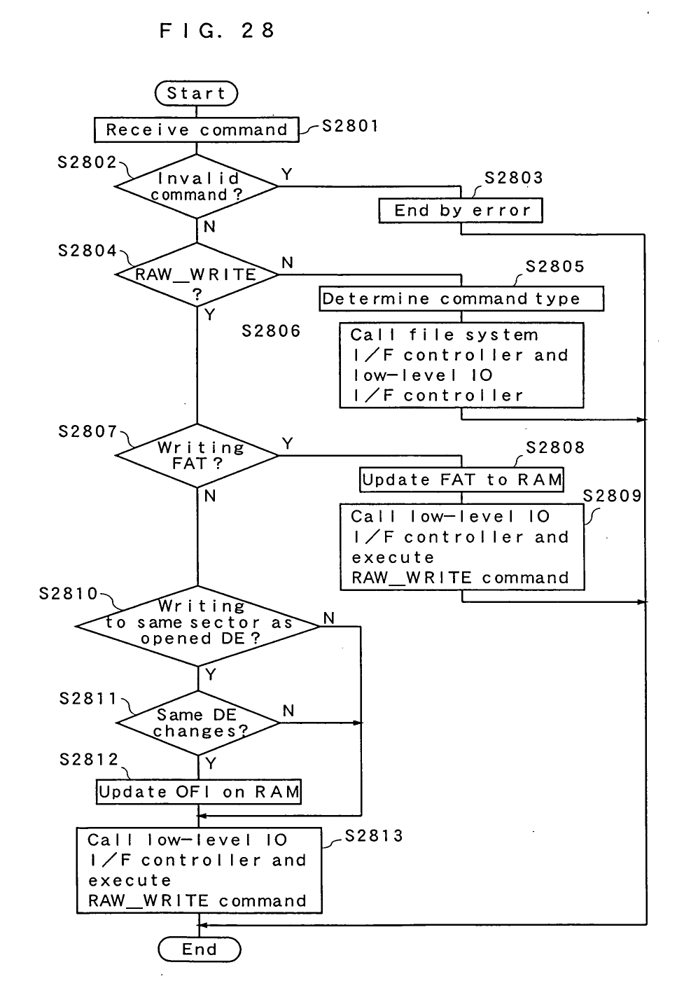

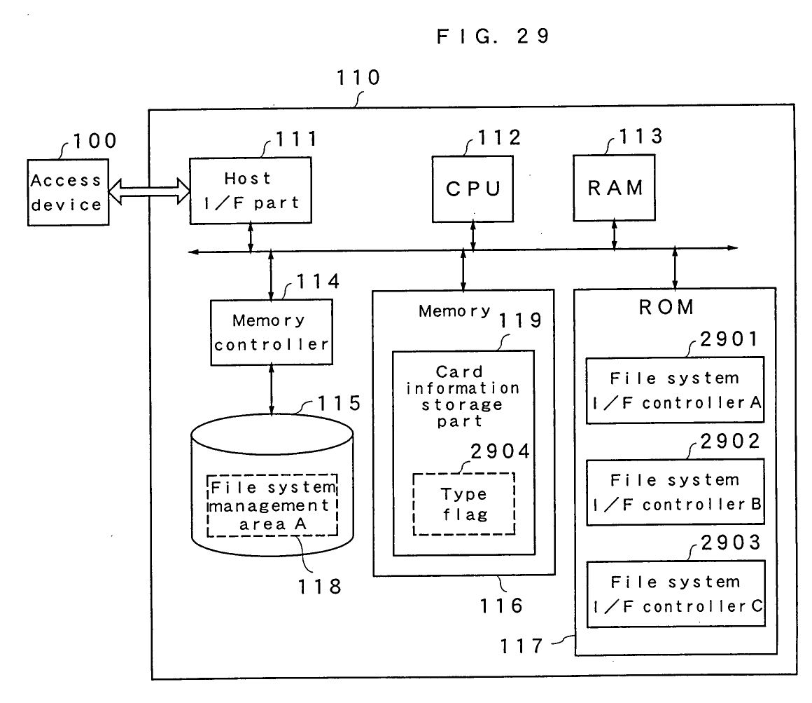

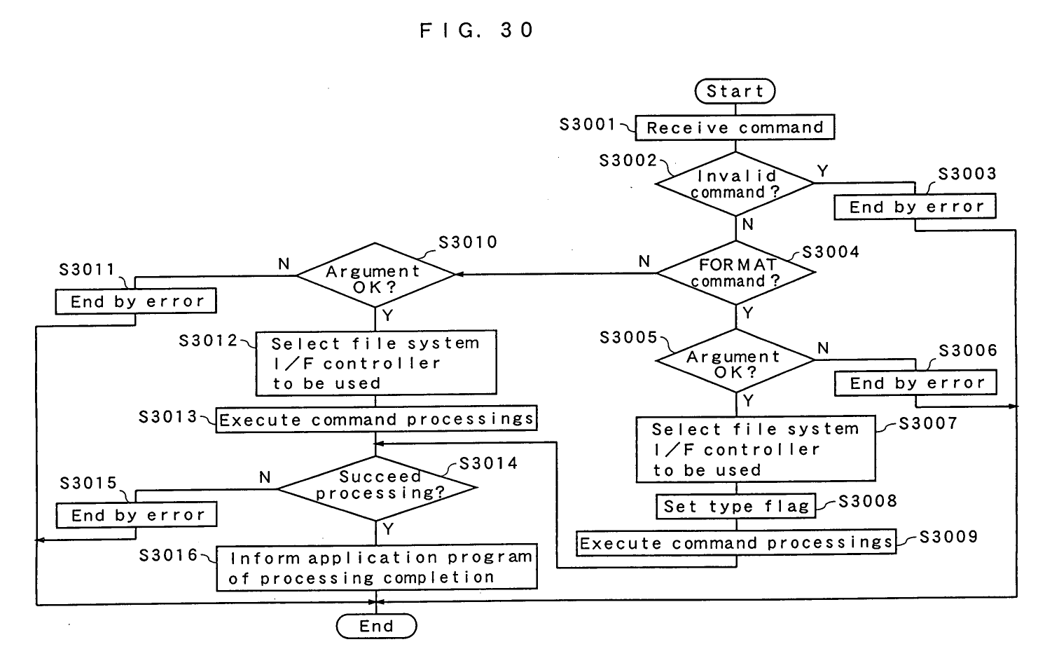

### BRIEF DESCRIPTION OF DRAWINGS

[FIG. 1] It shows a configuration view of a semiconductor memory card and access device in Embodiment 1 of the present invention.

[FIG. 2] It shows an explanation view showing an example of the relationship between erase blocks and sectors in Embodiment 1 of the present invention.

[FIG. 3] It shows a flowchart showing processing of writing data having a length of a multiple of the erase block to the semiconductor memory card in Embodiment 1.

[FIG. 4] It shows a flowchart showing processing of writing data of 1 sector to the semiconductor memory card in Embodiment 1.

[FIG. 5] It shows a configuration view of a FAT file system used in each embodiment of the present invention.

[FIG. 6] It shows a flowchart showing data writing processing of the FAT file system in Embodiment 1.

[FIG. 7] It shows an explanation view showing the FAT file system in a state before data writing in Embodiment 1.

[FIG. 8] It shows an explanation view showing the FAT file system in a state after data writing in Embodiment 1.

[FIG. 9] It shows an explanation view showing a list of a file system API.

[FIG. 10] It shows a flowchart showing internal processing of an access device in Embodiment 1.

[FIG. 11] It shows a flowchart showing card type acquisition command processing in the semiconductor memory card in Embodiment 1.

[FIG. 12] It shows a flowchart showing OPEN command processing in the semiconductor memory card in Embodiment 1.

[FIG. 13] It shows a flowchart showing WRITE command processing in the semiconductor memory card in Embodiment 1.

[FIG. 14] It shows a flowchart showing CLOSE command processing in the semiconductor memory card in Embodiment 1.

[FIG. 15] It shows an explanation view showing an example of data arrangement in Embodiment 1.

[FIG. 16] It shows a configuration view of the semiconductor memory card and an access device in Embodiment 2 (first) of the present invention.

[FIG. 17] It shows a configuration view of the semiconductor memory card and an access device in Embodiment 2 (second) of the present invention.

[FIG. 18] It shows an explanation view showing a list of low-level IOAPI in Embodiment 2.

[FIG. 19] It shows a flowchart showing internal processing in the access device in Embodiment 2.

[FIG. 20] It shows a flowchart showing file open processing of the file system controller in the access device in Embodiment 2.

[FIG. 21] It shows a flowchart showing file data writing processing of the file system controller in the access device in Embodiment 2.

[FIG. 22] It shows a flowchart showing file close processing of the file system controller in the access device in Embodiment 2.

[FIG. 23] It shows a configuration view of the semiconductor memory card and the access device in Embodiment 3 of the present invention.

[FIG. 24] It shows an explanation view showing a configuration example of the file system after formatting in Embodiment 3.

[FIG. 25] It shows a configuration view of the semiconductor memory card and the access device in Embodiment 4 of the present invention.

[FIG. 26] It shows an explanation view showing a data storage example in a RAM in the semiconductor memory card in Embodiment 4.

[FIG. 27] It shows an explanation view showing an example of a cache management table in Embodiment 4.

[FIG. 28] It shows a flowchart showing a processing procedure of a synchronization controller in the semiconductor memory card in Embodiment 4.

[FIG. 29] It shows a configuration view of the semiconductor memory card and the access device in Embodiment 5 of the present invention.

[FIG. 30] It shows a flowchart showing internal processing in the semiconductor memory card in Embodiment 5.

### DESCRIPTION OF REFERENCE NUMERALS

100 Access device
101, 112 CPU
102, 113 RAM
103 Slot
104, 117 ROM
105 Application program
106 Card interface controller
110 Semiconductor memory card
111 Host interface part
114 Memory controller
115 Nonvolatile memory
116 Memory
118, 1601, 1602 File system management area
119 Card information storage part
120, 2901, 2902, 2903 File system interface controller
501 Management information area
502 Data area
503 Master boot record and partition table
504 Partition boot sector
505, 506 FAT
507 Route directory entry
701 Directory entry
1603 Low-level IO interface controller
1701 File system controller
2501 Synchronization controller
2601 FAT (on RAM)
2602, 2603, 2604, 2605 Open file information
2606 Cache management table
2904 File system type flag

### BEST MODE FOR CARRYING OUT THE INVENTION

Hereinafter, embodiments of a semiconductor memory device according to the present invention will be described taking a semiconductor memory card as an example referring to figures.

### Embodiment 1

FIG. 1 is a configuration view of main parts of a semiconductor memory card and access device in accordance with Embodiment 1 of the present invention. In FIG. 1, an access device 100 includes a CPU 101, RAM 102, slot 103 and ROM 104. The ROM 104 stores programs for controlling the access device 100. The programs include an application program 105 and a control program for achieving functions of a card interface controller (card I/F controller) 106 and run on the CPU 101 using the RAM 102 as a temporary storage memory area.

The slot 103 is a connection part between the semiconductor memory card 110 and the access device 100 and a control signal and data are transmitted/received between the access device 100 and semiconductor memory card 110 through the slot 103. The application program 105 in the ROM 104 controls the whole of the access device 100 and the card interface controller 106 controls an access from the access device 100 to the semiconductor memory card 110.

On the other hand, in FIG. 1, the semiconductor memory card 110 includes a host interface part (host 1/F part) 111, CPU 112, RAM 113, memory controller 114, nonvolatile memory 115, memory 116 and ROM 117. The host interface part 111 is an interface for receiving commands and data including the control signal from the access device 100 that exists outside of the semiconductor memory card 110 and, in addition, for transmitting/receiving a response to/from the access device 100. The ROM 117 stores a program for controlling the semiconductor memory card 110 and this program runs on the CPU 112 using the RAM 113 as a temporary storage area. The ROM 117 includes a file system interface controller (file system I/F controller) 120 that performs file system control for managing data on the nonvolatile memory 115 as a file.

When the command including a control signal is input from the access device 100 via the host interface part 111, the memory controller 114 controls erase, writing and reading of data to the nonvolatile memory 115. The nonvolatile memory 115 has a data storage area in which user data and the like are stored and includes a file system management area 118 controlled by the file system interface controller 120. The memory 116 is updatable nonvolatile memory and has a card information storage part 119 for storing card information of the semiconductor memory card 110. Generally, the card information storage part 119 is a device information storage part. As described later, the card information is information on physical properties of the semiconductor memory card of the nonvolatile memory 115, for example, erase block size and card type.

Subsequently, characteristics of a nonvolatile semiconductor memory used as a recording device of the semiconductor memory card 110 will be described. The semiconductor memory can constitute a compact and light-weight information recording medium and have established a strong position as an information recording medium in various technical fields. The semiconductor memory uses a nonvolatile memory referred to as an EEPROM or flash ROM (hereinafter referred to as a flash memory) as a device for recording information. The nonvolatile memory 115 of the present embodiment has a lot of blocks each serve as a minimum unit of data erasing. Each block consists of a particular number of a plurality of continuous sectors. In the nonvolatile memory 115, data is read/written from/to the access device 100 via the host interface part 111.

An NAND flash memory used in many nonvolatile memories, especially, has a character that data must be written only after data already recorded is once erased prior to writing of data to return to an unrecorded state. Here, a data erase unit is referred to as an erase block and is managed as a block formed by aggregating a plurality of sectors, each sector being a minimum access unit, for example, the i^{th} power of 2 continuous sectors (i is an integer of 0 or more) together. FIG. 2 is an explanation view showing an example of the relationship between the erase blocks and sectors in the flash memory. In the example in FIG. 2, one erase block consists of i=5, that is, 32 sectors. Though, an access can be made in units of sectors (for example, 512 bytes), required data erase processing prior to writing is performed in the units of erase blocks (16 kB).

Examples of data erase and writing processing of the semiconductor memory card 110 will be described referring to FIGS. 3 and 4. FIGS. 3 and 4 are flowcharts showing an example of writing processing. FIG. 3 especially shows a processing in the semiconductor memory card 110 in the case where data having a length of a multiple of the erase block is written and FIG. 4 shows a processing in the semiconductor memory card 110 in the case where data of 1 sector is written.

In the data recording processing in FIG. 3, a command and an argument transmitted from the access device 100 are received via the host interface part 111 (S301). Next, referring to the received command, determination is made whether or not the command is an invalid command that cannot be recognized by itself (S302). In the case of an invalid command (Y at S302, hereinafter, which means Yes), an error is informed to the access device 100 and processing finishes (S303). In the case of a recognizable command (N at S302, hereinafter, which means No), determination is made whether or not the command is a writing command (S304). In the case of a command other than the writing command, other processing corresponding to the respective command is performed (S305). In the case of the writing command, determination is made whether or not the argument designated along with the command is correct (S306). When the argument is judged as an invalid argument, an error is informed to the access device 100 and processing finishes (S307).

When the argument is judged as correct one, a physical address of the erase block in the flash memory to which data is actually written is determined based on information stored in the argument, such as writing position and writing size (S308). Next, prior to writing, data that exists in the flash memory and exists at the erase block (physical block) determined at S308 is erased via the memory controller 114 (S309). Next, data of 1 sector is received from the access device 100 via the host interface part 111 (S310). When receipt of the data is completed, the received data of 1 sector is written to the nonvolatile memory 115 via the memory controller 114 (S311). The data receipt processing at S310 and writing processing at S311 are repeated until writing of the data for 1 erase block finishes (S312). The writing processing of data for one erase block at S308 to S312 is repeated until data writing of the writing size designated by the access device 100 finishes (S313). When data writing of the writing size designated by the access device 100 finishes, processing is completed.

In the data recording processing in FIG. 4, processings at S401 to S411 are the same as those at S301 to S311 in FIG. 3. A point different from the processing in FIG. 3 is that data other than the data of 1 sector received from the access device 100 among the data contained in the erase block in which writing is performed at S412 is written in the erase block determined at S408. In the NAND flash memory, prior to writing of data, data needs to be erased once. Since this erase processing can be performed only in the units of erase blocks, even when data of 1 sector is written, data of 1 erase block needs to be erased. Furthermore, as shown in the processing at S412, it is necessary to rewrite existing data of the other sectors contained in the same erase block as a block of an updated sector into a new erase block.

As shown in FIGS. 3 and 4, the data recording processing is roughly classified into three types of processings, command interpretation processing, data erase processing and data writing processing. For example, a flash memory taking 3 ms for overhead in command interpretation, 200 μs for writing of 1 sector and 2 ms for erase processing of 1 erase block (16 kB) is assumed. In writing of 1 erase block (16 kB) of the flash memory, the processing shown in FIG. 3 is performed and takes 3 ms for command interpretation, 2 ms for erase processing and 32×200 μs for writing processing, which amounts to 11.4 ms in total.

Similarly, in writing in 1 sector (512B), the processing shown in FIG. 4 is performed and takes 3 ms for command interpretation, 2 ms for erase processing and 200 μs+31×200 μs for writing processing, which amounts to 11.4 ms in total. That is, writing of data of 16 kB and writing of data of 1 sector require substantially the same processing time. In this example, a case where an extreme difference in performance appears is explained without considering data transfer time and the like but, even in the actual flash memory, writing time becomes minimum in a case where writing in the units of erase blocks is performed.

The number of the flash memories used as the recording device of the semiconductor memory card 110 is not limited to 1 and the semiconductor memory card 110 which uses a plurality of flash memories for parallel processing to improve access capabilities exists. Such semiconductor memory card 110 controls the flash memories using a plurality of erase blocks as a management unit and when writing is performed in the management units, writing time becomes minimum value. As described above, the access properties of the semiconductor memory card 110 depend on the type and the number of the used flash memories and the management method of the flash memories, and vary with generations and manufacturers of the semiconductor memory card 110. The card information stored in the card information storage part 119 has physical properties and card type information. The physical properties include the overhead for command interpretation, writing processing time of 1 sector, erase time of 1 erase block and erase block size and information on an optimum access unit or card information necessary for determining the optimum access unit, and the card type information includes version information of the semiconductor memory card.

Subsequently, as an example of file systems that manage data stored in the nonvolatile memory 115 in the semiconductor memory card 110, the FAT file system will be described. FIG. 5 shows configuration of the FAT file system. The file system management area 118 means an area managed by a file system in the nonvolatile memory 115 in the semiconductor memory card 110. According to the FAT file system, a management information area 501 for managing the whole of the file system management area exists at the head of a file system management area 118, followed by a data area 502 for storing the user data and the like in the file. The management information area 501 consists of a master boot record and partition table (MBR/PT) 503, partition boot sector (PBS) 504, FAT 505, FAT 506 and route directory entry (RDE) 507.

The master boot record and partition table 503 is a part that stores information for managing the file system management area by dividing the area into a plurality of areas called partitions. The partition boot sector 504 is a part that stores management information in one partition. The FATs 505 and 506 are parts for showing physical storage positions of data contained in a file. The route directory entry 507 is a part that stores information on a file and directory existing just under a route directory. Since the FATs 505 and 506 are important areas for showing physical storage positions of data contained in a file, duplication is generally made by providing the FATs 505 and 506 having the same information in the file system management area 118.

The data area 502 is managed by being divided into a plurality of clusters and each cluster stores data contained in a file. A file and the like storing a lot of data stores data striding over a plurality of clusters and linkage between the clusters is managed by link information stored in the FATs 505 and 506.

Referring to FIGS. 6, 7 and 8, an example of writing of file data in the FAT file system will be described. FIG. 6 is a flowchart showing a writing processing of a file data in the FAT file system. FIGS. 7 and 8 are explanation views each showing, respectively before and after writing processing, an example of a directory entry 701, FATs 505 and 506 and data area 502. In the FAT file system, the directory entry 701 that stores information such as a file name, file size and file attribute is stored in a part of the route directory entry 507 and data area 502 and FIG. 7 (a) shows an example of the directory entry 701. In the example of the file shown in the directory entry 701, the file name is FILE1.TXT and file data starting from a cluster number 10 is stored. The file size is 16000 bytes. In FIG. 7, the size of 1 cluster is assumed to be 4096 bytes and the file data is stored striding over 4 clusters.

Referring to FIG. 6, a writing processing of a file data will be described. In the writing processing of a file data, first, the directory entry 701 of a target file is read (S601). Next, a start cluster number of the file stored in the read directory entry 701 is acquired to confirm a leading position of the file data (S602). Next, the FATs 505 and 506 are read, a link is sequentially tracked on the FATs 505 and 506 from the leading position of the file data acquired at S602 and cluster number at writing position is acquired (S603).

Next, at the time of writing the data, it is determined whether a new free area needs to be allocated to the file (S604). When the allocation of the free area is unnecessary, the processing proceeds to processing at S606. When allocation of the free area is necessary, the free area is searched on the FATs 505 and 506 and the free area of 1 cluster is allocated to a termination of the file (S605). Subsequently, all data that can be written into the currently referred cluster is written to the data area 502 (S606). Next, it is determined whether writing of all data has finished (S607). When data still remains, the processing returns to the processing at S604. When writing of all data is finished, the file size, time stamp, and the like stored in the directory entry 701 are updated and written to the semiconductor memory card 110 (S608). Finally, the FATs 505 and 506 are written to the semiconductor memory card 110 to complete processing (S609).

When data of 1000 bytes is further written to FILE1.TXT having data of 16000 bytes as shown in FIG. 7 through writing processing of such file data, the file is changed to a file having data of 17000 bytes as shown in FIG. 8.

As described above, in the FAT file system, an area is allocated to be file data storage area in the units of clusters and data is stored. A plurality of clusters allocated to 1 file is not necessarily continuous and discontinuous areas may be allocated. In a worst case, a file data may be written to the discontinuous areas divided in the units of clusters. In this case, the size of one access to the semiconductor memory card 110 becomes a size of 1 cluster or less and when the access unit necessary for accessing the semiconductor memory card 110 at the highest rate is larger than the cluster size, access with the best performance of the semiconductor memory card 110 becomes impossible. This problem occurs in the other file systems as well as the FAT file system.

For this reason, in the present embodiment, the card information storage part 119 is provided for storing card information including physical properties of the semiconductor memory card 110. The file system interface controller 120 is provided in the semiconductor memory card 110 to perform file access suitable for the physical properties of the semiconductor memory card 110 on the basis of the card information. Thus, the access device 100 can perform optimum file access without taking into account of the access properties of the semiconductor memory card 110.

Subsequently, a function of the file system interface controller 120 in the present embodiment will be described. In the present embodiment, the file system interface controller 120 in the semiconductor memory card 110 controls the file system built on the nonvolatile memory 115 in the semiconductor memory card 110. Thus, the access device 100 issues a file access request to the semiconductor memory card 110 to access to a file stored in the nonvolatile memory 115 in the semiconductor memory card 110.

FIG. 9 is a view showing a list of upper group of commands (hereinafter referred to as file system API) received by the file system interface controller 120 from the access device 100. As shown in FIG. 9, the file system interface controller 120 accepts file access requests such as OPEN (open the file), CLOSE (close the file), READ (read data from the file) and WRITE (write data to the file) from the access device 100 and provides the functions of the file system to the access device 100. That is, based on the card information stored in the card information storage part 119, the file system interface controller 120 manages the data stored in the nonvolatile memory 115 as the file and according to the command input from the access device 100 through the host interface part 111, performs file access processing including OPEN, CLOSE, READ and WRITE with respect to the file in the nonvolatile memory 115.

According to such method, it is unnecessary to provide the file system on the side of the access device 100. All of the functions of the file system are provided from the side of the semiconductor memory card 110.

Next, referring to FIGS. 10 to 14, an example in which the access device 100 accesses the file through the file system interface controller 120 will be described. Here, as an example of file access, an example in which the file is prepared just under the route directory and data is written to the file will be described. FIG. 10 is a flowchart showing a processing procedure on the side of the access device 100. FIGS. 11, 12, 13 and 14 are flowcharts showing processing procedures on the side of the semiconductor memory card 110 in the card type acquisition command, OPEN command, WRITE command and CLOSE command issued by the access device 100 to the semiconductor memory card 110, respectively.

First, referring to FIG. 10, a processing procedure on the side of the access device 100 will be described. First, the access device 100 issues the card type acquisition command to the semiconductor memory card 110 to acquire the card type information as information on the version of the semiconductor memory card 110 and the like (S1001). Next, it is determined whether the card type information can be acquired from the semiconductor memory card 110 according to the issued command (S1002). When acquisition fails, the access device 100 determines that an error has occurred and finishes the processing (S1003).

When acquisition succeeds, it is determined whether the semiconductor memory card 110 accepts the file system API (S1004). When the semiconductor memory card 110 does not accept the file system API, access using the file system API cannot be performed and thus processing is finished (S1005). When the semiconductor memory card 110 accepts the file system API, a file name is designated and the OPEN command is issued to the semiconductor memory card 110 to prepare the file (S1006).

Next, it is determined whether the processing according to the issued OPEN command succeeds (S1007). When the processing fails, processing is finished due to error (S1008). When processing succeeds, as a response to the OPEN command, a file handle (identifier) used to access the prepared file is acquired from the semiconductor memory card 110. Next, data to be stored in the file is created (S1009). Next, to write the created data to the file, the file handle, writing size, created data and the like that are acquired according to the OPEN command are designated and a WRITE command is issued to the semiconductor memory card 110 (S1010).

Next, it is determined whether or not the processing according to the issued WRITE command succeeds (S1011). When the processing fails, processing is finished due to error (S1012). When the processing succeeds, the file handle is designated and the CLOSE command is issued to the semiconductor memory card 110 (S1013). Next, it is determined whether or not the processing according to the issued CLOSE command succeeds (S1014). When the processing fails, processing is finished due to error (S1015). When the processing succeeds, file creation and data writing processing are completed.

Among the above-mentioned processings, the command issuance processings at S1001, S1006, S1010 and S1013 are performed by the card interface controller 106 in the access device 100 and the other processing is performed by the application program 105.

Next, referring to FIGS. 11 to 14, a processing procedure on the side of the semiconductor memory card 110 will be described. FIG. 11 is a flowchart showing the processing procedure on the side of the semiconductor memory card 110 at issuance of the card type acquisition command. First, the semiconductor memory card 110 receives a command from the access device 100 (S1101). Next, referring to the received command, it is determined whether or not the command is an invalid command that cannot be recognized itself (S1102). When the command is the invalid command, an error is informed to the access device 100 to finish processing (S1103). When the command is a recognizable command, it is determined whether or not the command is the card type acquisition command (S1104). When the command is a command other than the card type acquisition command, the other processing corresponding to each command is performed (S1105). When the command is the card type acquisition command, the card type information stored in the card information storage part 119 is read (S1106). Finally, the card type information read last time is transmitted to the access device 100 and processing here is finished (S1107).

FIG. 12 is a flowchart showing a processing procedure on the side of the semiconductor memory card 110 at issuance of the OPEN command. First, the semiconductor memory card 110 receives a command from the access device 100 (S1201). Next, referring to the received command, it is determined whether or not the command is the invalid command that cannot be recognized itself (S1202). When the command is the invalid command, an error is informed to the access device 100 and the processing finishes (S1203). When the command is the recognizable command, it is determined whether the command is the OPEN command (S1204).

When the command is a command other than the OPEN command, the other processing corresponding to each command is performed (S1205). When the command is the OPEN command, it is determined whether an argument transmitted along with the command is correct (S1206). When determination is made that the OPEN processing cannot be performed, for example, when an invalid file name is designated by the argument, an error is informed to the access device 100 (S1207). When the argument is correct, a route directory entry area (RDE) is read into the RAM 113 (S1208).

Next, a free directory entry is acquired in the route directory entry area read into the RAM 113 (S1209). When acquisition fails, an error is informed to the access device 100 and the processing finishes (S1211). When acquisition succeeds, a directory entry (DE) of a file having the file name designated by the argument of the OPEN command is created on the RAM 113 (S1212). Next, the directory entry created on the RAM 113 is written to the nonvolatile memory 115 (S1213).

Next, information necessary for accessing the created file is created on the RAM 113 as an open file information (OFI) (S1214). The open file information includes a file name, file size, position of a directory entry, open attributes such as read-only open and write-only open and currently referring position in the file. Finally, a file handle that uniquely identifies the open file information is created and is informed to the access device 100 and the processing finishes (S1215). File access after OPEN processing is performed using the file handle.

FIG. 13 is a view showing a processing procedure on the side of the semiconductor memory card 110 at issuance of the WRITE command. First, the semiconductor memory card 110 receives a command from the access device 100 (S1301). Next, the received command is referred and it is determined whether or not the command is the invalid command that cannot be recognized itself (S1302). When the command is the invalid command, an error is informed to the access device 100 and the processing finishes (S1303). When the command is a recognizable command, it is determined whether or not the command is the WRITE command (S1304). When the command is a command other than the WRITE command, the other processing corresponding to each command is performed (S1305).

When the command is the WRITE command, it is determined whether an argument transmitted along with the command is correct (S1306). When determination is made that the WRITE processing cannot be performed, for example, when an invalid file handle is designated by the argument, an error is informed to the access device 100 and the processing finishes (S1307). When the argument is correct, the open file information (OFI) on the RAM 113 is identified based on the file handle (S1308). Next, referring to the identified open file information, the currently referring position in the file is confirmed (S1309). The currently referring position means the position where data is written to add next and when data is written from the end of the file, a free area needs to be acquired.

Next, prior to data writing, it is determined whether the free area needs to be acquired (S1310). When acquisition of the free area is unnecessary, the procedure proceeds to processing at S1315. When acquisition of the free area is necessary, referring to the FAT on the RAM 113, a free cluster is acquired (S1311). Here, it is assumed that the FAT is previously read from the nonvolatile memory 115 into the RAM 113. When acquisition fails, an error is informed to the access device 100 and the processing finishes (S1313). When acquisition succeeds, the FAT is updated on the RAM 113 and the free cluster acquired at S1311 is changed to a cluster in use (S1314).

Next, data is written to the position of the free cluster acquired at S1311 in the nonvolatile memory 115 (S1315). The processing from S1310 to S1315 is repeated until writing of all data finishes (S1316). When writing of all data finishes, information such as the file size stored in the open file information on the RAM 113 is updated (S1317). Finally, completion of the processing is informed to the access device 100 and the processing finishes (S1318).

FIG. 14 is a flowchart showing a processing procedure on the side of the semiconductor memory card 110 at issuance of the CLOSE command. First, the semiconductor memory card 110 receives a command from the access device 100 (S1401). Next, referring to the received command, it is determined whether or not the command is the invalid command that cannot be recognized itself (S1402). When the command is the invalid command, an error is informed to the access device 100 and the processing finishes (S1403). When the command is the recognizable command, it is determined whether the command is the CLOSE command (S1404).

When the command is a command other than the CLOSE command, the other processing corresponding to each command is performed (S1405). When the command is the CLOSE command, it is determined whether or not an argument transmitted along with the command is correct (S1406). When determination is made that the CLOSE processing cannot be performed, for example, when an invalid file handle is designated by the argument, an error is informed to the access device 100 and the processing finishes (S1407). When the argument is correct, the open file information on the RAM 113 is identified based on the file handle (S1408). Next, referring to the identified open file information, the storage position of the directory entry of the open file is identified and data for 1 sector including the directory entry is read into the RAM 113 (S1409).

Next, the file size, time stamp, and the like stored in the directory entry of the open file is updated on the RAM 113 (S1410). Next, the directory entry on the RAM 113 is written to the nonvolatile memory 115 (S1411). Next, the FAT on the RAM 113 is written to the nonvolatile memory 115 (S1412). After writing of the directory entry and FAT has finished, the open file information on the RAM 113 is cleared to change state to that which the file is not opened (S1413). Finally, completion of the processing is informed to the access device 100 and the processing finishes (S1414).

In the present embodiment, the access device 100 only issues the command of the file system API and control of the file system is performed on the side of the semiconductor memory card 110. For this reason, the access device 100 can perform optimum file access in the semiconductor memory card 110 without taking into account of the access properties of the semiconductor memory card 110.

Subsequently, a part that the file system interface controller 120 of the semiconductor memory card 110 performs file access according to the physical properties of the semiconductor memory card 110 will be further described. In the present embodiment, the file system interface controller 120 acquires card information on the physical properties of the semiconductor memory card 110 from the card information storage part 119 and file access is performed on the basis of the information. Thus, it is possible to achieve optimum file access according to the physical properties of the semiconductor memory card 110. Hereinafter, two examples in which file access is performed on the basis of the card information acquired from the card information storage part 119.

As a first example, a file data writing method taking into account of an optimum access unit of the semiconductor memory card 110 will be described. The optimum access unit for accessing the semiconductor memory card 110 at high rate depends on the type and number of flash memories to be used and a management method of the flash memories, and varies with generations and manufacturers of the semiconductor memory card 110. In the present embodiment, information on the optimum access unit or card information necessary for determining the optimum access unit is stored in the card information storage part 119 and the file system interface controller 120 performs file access taking into account of the optimum access unit. The optimum access unit means a most efficient unit for access to the nonvolatile memory 115. When one nonvolatile memory chip is used, the erase block itself is the optimum access unit. When a plurality of, for example, 8 nonvolatile memory chips are used in parallel, 8 times of the erase block of each memory chip, for example, 16 kB×8=128 kB, is the optimum access unit.

FIG. 15 is a view showing an example of data arrangement in the data area 502 in the file system built in the nonvolatile memory 115. In this example, the file system executes management by treating 1 cluster as 16 kB and the semiconductor memory card 110 having the optimum access unit of 128 kB is assumed. In a conventional file system, when the free area is acquired in writing file data, since arbitrary free area is allocated to the file without taking into account of the optimum access unit, for example, the area of cluster number 4 in FIG. 15 is allocated and data is written in the units of clusters. On the contrary, in the file access in the present embodiment, the free area of the optimum access unit is allocated taking into account of the optimum access unit.

Thus, the area where a part of the optimum access unit is used, such as the optimum access units 0 and 1 in FIG. 15, is not allocated to the file data, while the area where all of the optimum access unit is free, such as the optimum access unit 2, is allocated and data is written in the optimum access unit. The allocation of a free area in the optimum access unit is specifically performed in the processing at S1311 in the WRITE command processing procedure shown in FIG. 13. By allocating the area in this manner, in the case of a file having somewhat large file size, the access device side can access the semiconductor memory card 110 in the optimum access unit without any acceptance. Thus, it becomes possible to access the semiconductor memory card 110 at high rate. Since a new area is used in the optimum access unit each time of data writing, defragmentation processing of aggregating scattered data in the optimum access unit including the free area is considered to be performed in the background where no processing is carried out.

As a second example, a method for allocating the directory area taking into account of the optimum access unit of the semiconductor memory card 110. In the case where a new directory is created or a new area needs to be allocated to the directory area when creating a new file, since the conventional file system allocates an arbitrary area as in the above-mentioned example in acquiring a free area during allocating the directory area, for example, the area having the cluster number 18 in FIG. 15 is allocated. In this case, since the used area is contained in the optimum access unit 2 by using the area having the cluster number 18 as the directory area, and the area cannot be used for assignment of the file data area, which is described in the first example.

For this reason, the file system interface controller 120 in the present embodiment preferentially uses the area in which the directory area is already allocated in a part of the optimum access unit as an allocation area for directory area, thereby allowing the directory areas to be included in the same optimum access unit as far as possible. That is, in the example in FIG. 15, the area having cluster numbers 12 to 17 included in the optimum access unit 1, in which the directory area is already allocated, is allocated as the directory area. Thus, it becomes easy to generate a continuous free area in the optimum access unit and file data allocation in the first example can be effectively performed. As a result, file access at high rate can be achieved.

As described above, in the present embodiment, the card information storage part 119 for storing the card information containing the physical properties of the semiconductor memory card 110 and the file system interface controller 120 for performing file access suitable for the physical properties of the semiconductor memory card 110 are provided in the semiconductor memory card 110 on the basis of the card information. Thus, the access device 100 can perform optimum file access without taking into account of the access properties of the semiconductor memory card 110. Since the access device need not deal with various semiconductor memory card for optimum access, the amount of verification operation for dealing with the cards is also decreased.

Furthermore, since the access device 100 that can interpret the file system API described in the present embodiment need not recognize the type of the file system built on the semiconductor memory card 110, it becomes possible to access a plurality of semiconductor memory cards 110 managed by different file systems. In other words, irrespective of the type of a file system built on the semiconductor memory card 110, data can be exchanged.

The processing procedure of the access device 100 and the semiconductor memory card 110 described referring to FIGS. 10 to 14 is an example and a different processing procedure from that in the above-mentioned embodiment may be used as long as the access device 100 issues a file system API command and there is a method for executing a file system control on the semiconductor memory card 110 side.

In the present embodiment, the example in which the file system interface controller 120 determines the optimum access unit on the basis of the card information stored in the card information storage part 119 is described. However, the other method may be used as long as the file system interface controller 120 can acquire the optimum access unit on the basis of the card information stored in the card information storage part 119. For example, it can be considered that the access device 100 reads the card information stored in the card information storage part 119, determines and informs the optimum access unit to the file system interface controller 120.

Furthermore, the file system API shown in FIG. 9 is an example. Only a part of the API in FIG. 9 may be selected and used or the other API concerning file system control may be added and used. Although the FAT file system is described as an example in the present embodiment, the other file systems may be used. The card information stored in the card information storage part 119 may be updated depending on the use conditions of the semiconductor memory card 120. The memory 116 including the card information storage part 119 may be included in the nonvolatile memory 115 or when the card information is not updated, the memory 116 may be included in the ROM 117.

As described above, Embodiment 1 is characterized by that the nonvolatile memory for storing the user data and the like, the card information storage for storing the card information of the semiconductor memory card and the file system interface controller for performing file access suitable for the properties of the semiconductor memory card on the basis of the card information stored in the card information storage are provided in the semiconductor memory card.

### Embodiment 2

Next, the semiconductor memory card in accordance with Embodiment 2 of the present invention will be described. FIG. 16 is a configuration view of the semiconductor memory card and the access device in the present embodiment (first). FIG. 17 is a configuration view of the semiconductor memory card and the access device in the present embodiment (second). The semiconductor memory card 110 shown in FIG. 16 is different from the semiconductor memory card 110 shown in FIG. 1 in that an area in the nonvolatile memory 115 is divided into two separate logical access groups and there are a file system management area A (first area) 1601 and a file system management area B (second area) 1602. Moreover, in addition to the file system interface controller 120, a low-level IO interface controller 1603 is provided in the ROM 117 of the semiconductor memory card 110.

The configuration shown in FIG. 17 is different from the configuration shown in FIG. 16 in that in addition to the application program 105 and the card interface controller 106, a file system controller 1701 is provided in the ROM 104 of the access device 100. The access device 100 is a component that becomes necessary when data is recorded or read to or from a conventional semiconductor memory card (without the file system interface controller).

The file system interface controller 120 shown in FIG. 16 manages data stored in the nonvolatile memory 115 as a file on the basis of card information stored in the card information storage part 119 and when the access device 100 issues a command to request file access processing such as OPEN, CLOSE, READ and WRITE with respect to a file on the nonvolatile memory 115 via the host interface part 111, performs the access processing to the file existing in the nonvolatile memory 115.

When the access device 100 inputs the command to request data writing or reading processing to or from the second area 1602 of the nonvolatile memory 115 via the host interface part 111, the low-level IO interface controller 1603 performs the data writing or reading processing to or from the second area 1602 in the nonvolatile memory 115. A point different from the file system interface controller 120 is that the low-level IO interface controller 1603 performs only access control such as data writing or reading processing to or from the second area 1602 of the nonvolatile memory 115 without performing control of the file system.

When accessing the semiconductor memory card 110 via the low-level IO interface controller 1603, the access device 100 is configured as shown in FIG. 17. In this case, as shown in FIG. 17, the file system controller 1701 on the side of the access device 100 controls the file system in the semiconductor memory card 110. On the other hand, the access device 100 accessing the semiconductor memory card 110 via the file system interface controller 120 is configured as shown in FIG. 16. In this case, as in Embodiment 1 of the present invention, the file system controller 1701 is not provided on the side of the access device 100.

As shown in FIG. 16, the area of the nonvolatile memory 115 is divided into a file system management area A1601 and a file system management area B1602, the file system management area A1601 is controlled by the file system interface controller 120 and the file system management area B1602 is controlled by the low-level IO interface controller 1603.

That is, in the present embodiment, the semiconductor memory card 110 has two kinds of interface controllers for accepting access from the access device 100 and the areas to be accessed by interface controllers are separated from each other. Thus, it is possible to access the semiconductor memory card 110 even from the access device 100 that can only interpret any of the two interface controllers, thereby improving compatibility of the access device.

Subsequently, a function of the low-level IO interface controller 1603 in the present embodiment will be described. In the present embodiment, the nonvolatile memory 115 in the semiconductor memory card 110 is divided into two management areas A and B, the file system management area A1601 is controlled by the file system interface controller 120 and the file system management area B1602 is controlled by the low-level IO interface controller 1603. Since the method of access via the file system interface controller 120 is the same as the method described in Embodiment 1, description thereof is omitted. Here, a method of access via the low-level IO interface controller 1603 will be described.

FIG. 18 is a view showing a list of command group (hereinafter, referred to as low-level IOAPI) that the low-level IO interface controller 1603 accepts from the access device 100. As shown in FIG. 18, the low-level IO interface controller 1603 accepts input/output requests of a lower level than the file system shown in FIG. 9, including RAW_READ (read data) and RAW_WRITE (write data) from the access device 100 and provides these low-level IO functions. That is, in the present embodiment, the access device 100 that accesses via the low-level IO interface controller 1603 needs to have the file system controller 1701 for controlling the file system as mentioned above.

Next, referring to FIGS. 19 to 22, an example in which the access device 100 accesses a file via the low-level IO interface controller 1603 will be described. As the example of file accessing, an example in which a file is prepared just under the route directory and data is written thereto will be described. FIG. 19 is a flowchart showing all processing procedures on the side of the access device 100. FIGS. 20, 21 and 22 are flowcharts showing processing procedures for file open processing, data writing processing and file close processing that are performed by the file system controller 1701 in the access device 100, respectively.

First, using FIG. 19, the processing procedure on the side of the access device 100 will be described. The processing procedure FIG. 19 is different from the processing procedure shown in FIG. 10 in that each processing of file open, data writing and file close is not done on the side of the semiconductor memory card 110 but in the file system controller 1701 in the access device 100. Specifically, respective processings at S1906, S1910 and S1913 in FIG. 19 are processing procedures shown in FIGS. 20 and 22 described later and are performed by the file system controller 1701 in the access device 100. That is, in FIG. 19, processing at S1901 is performed by the card interface controller 106, respective processings at S1906, S1910 and S1913 are performed by the file system controller 1701 and the other processing is performed by the application program 105.

Next, referring to FIGS. 20 to 22, the processing procedure performed by the file system controller 1701 in the access device 100 is described. Since the processing procedure on the side of the semiconductor memory card 110 at issuance of the card type acquisition command is the same as the procedure in FIG. 11, description thereof is omitted. The processing procedures for the file open processing, data writing processing and file close processing shown in FIGS. 20 to 22 are substantially the same as the processing procedures shown in FIGS. 12 to 14 and thus, only differences are described.

The first difference is that processing from command receipt to command interpretation (processings at S1201 to S1205 in FIG. 12) does not exist. Since these processings are performed for interpreting the command on the side of the semiconductor memory card 110 and are unnecessary in processing performed by the file system controller 1701 in the access device 100, the processings are omitted from the processing procedure.

The second difference is that the processing of reading/writing data from/to the nonvolatile memory 115 is described as RAW_READ command issuance or RAW_WRITE command issuance and a judgment of the success or failure of each command is added. The file system interface controller 120 in the semiconductor memory card 110 accesses the nonvolatile memory 115 in Embodiment 1, while, in the present embodiment, the card interface controller 106 in the access device 100 issues the low-level IOAPI command and accesses via the low-level IO interface controller 1603 of the semiconductor memory card 110. In this manner, the processing of access to the nonvolatile memory 115 is changed to the low-level IOAPI command issuance processing.

As described above, the card information storage part 119 for storing the card information containing the physical properties of the semiconductor memory card 110 of the semiconductor memory card, the file system interface controller 120 for performing file access suitable for the physical properties of the semiconductor memory card 110 on the basis of the card information, the low-level 10 interface controller 1603 for accepting the low-level 10 request and the nonvolatile memory 115 are provided in the semiconductor memory card 110. The area in the nonvolatile memory 115 is divided into two areas and each area is accessed by the file system interface controller 120 and the low-level 10 interface controller 1603, respectively. With such configuration, it is possible to access the semiconductor memory card 110 even from the access device that can only interpret any of the two interfaces, for example, a conventional access device.

In the present embodiment, file access via the low-level IO interface controller 1603 is described using FIGS. 20 to 22. These processings are the same as the processings in the case where the file system is controlled on the side of the access device 100 in a conventional access device 100. A central aim in the present embodiment is that the two interface controllers 120 and 1603 are provided on the side of the semiconductor memory card 110 and the access device 100 can access the semiconductor memory card 110 via any of the interface controllers. For this reason, the processing procedures shown in FIGS. 20 to 22 are examples and the other processing procedures may be adopted as long as the file system controller 1701 is provided on the side of the access device 100 and there is a method for accessing the semiconductor memory card 110 via the low-level IO interface controller 1603.

Furthermore, the low-level IOAPI shown in FIG. 18 is an example. Only a part of the API in FIG. 18 may be selected and used or the other API concerning the other low-level IO may be added and used. Although the FAT file system is described as an example in the present embodiment, the other file systems may be used. The card information stored in the card information storage part 119 may be possible to update its value depending on the use conditions of the semiconductor memory card 120. The memory 116 including the card information storage part 119 may be included in the nonvolatile memory 115 or may be included in the ROM 117 when the card information is not updated.

As described above, Embodiment 2 is characterized by providing the nonvolatile memory, the area of which is divided into two areas, for storing the user data and the like, the card information storage for storing the card information concerning the physical properties of the semiconductor memory card, the file system interface controller for performing file access suitable for the physical properties of the semiconductor memory card on the basis of the information stored in the card information storage and the low-level IO interface controller for processing the low-level input/output requests with respect to the nonvolatile memory in the semiconductor memory card from the access device outside of the semiconductor memory card in the semiconductor memory card and by that these interface controller manages each area.

### Embodiment 3

Next, the semiconductor memory card in accordance with Embodiment 3 of the present invention will be described. FIG. 23 is a configuration view of the semiconductor memory card 110 and the access device 100 in Embodiment 3. The access device 100 shown in FIG. 23 is the same in configuration as the access device 100 shown in FIG. 17. The configuration of the semiconductor memory card 110 is different from that shown in FIG. 16 in that the area of the nonvolatile memory 115 is not divided into two areas and is formed of a single file system management area 118.

That is, in Embodiment 3, the file system interface controller 120 and the low-level IO interface controller 1603 are provided in the semiconductor memory card 110 and the access device 100 can access the semiconductor memory card 110 via any of the interface controllers in a similar way of Embodiment 2. Embodiment 3 is different from Embodiment 2 in that both of the file system interface controller 120 and the low-level IO interface controller 1603 control same area that is the file system management area 118. Hereinafter, functions of the two interface controllers 120 and 1603 in the present embodiment will be described.

In the present embodiment, it is required that there is not inconsistency in accessing same area via the two interface controllers in the file system. For this reason, in the present embodiment, control of the file system is basically performed by the file system controller 1701 on the side of the access device 100 and the file system interface controller 120 on the side of the semiconductor memory card 100 performs processing of assisting control of the file system within a range that inconsistency in the file system does not occur. That is, the file system interface controller 120 performs only format processing that builts the file system in the common area on the nonvolatile memory 115. The low-level 10 interface controller 1603 performs file access processing other than the format processing to the file existing in the common area on the nonvolatile memory 115 the command input from the file system controller 1701 in the access device 100.

As an example of the file system interface controller 120 in the present embodiment, a case where only the format function of the file system management area 118 is achieved will be described. Formatting of the file system is a required processing for managing data on the semiconductor memory card 110 by the file system and is performed in using the semiconductor memory card 110 for the first time or in erasing all data once.

In the example described here, only when formatting the file system, the access device 100 accesses the semiconductor memory card 110 via the file system interface controller 120. Furthermore, file access after formatting is performed via the low-level 10 interface controller 1603. By dividing the role (function) of the two interface controllers, it is assured that inconsistency in the file system does not occur even when the semiconductor memory card 110 is accessed via the two interface controller.

Furthermore, the file system interface controller 120 in the present embodiment acquires the card information concerning physical properties of the semiconductor memory card 110 from the card information storage part 119 and provides format function of the file system according to the properties. First, the file system interface controller 120 in the present embodiment determines the optimum access unit of the semiconductor memory card 110 on the basis of the card information acquired from the card information storage part 119. Second, when the file system management area 118 is formatted, the size of the management information area 501 from the master boot record partition table 503 to the route directory entry 507 is adjusted so as to be a length of a multiple of the optimum access unit.

Next, data arrangement after the format processing in the present embodiment will be described referring to FIG. 24. FIG. 24 is a view showing an example of data arrangement in the case where the file system interface controller 120 in the present embodiment formats the file system management area 118. In FIG. 24, the MBR/PT denotes the master boot record partition table 503, the PBS denotes the partition boot sector 504 and the RDE denotes the route directory entry 507.

As shown in FIG. 24, the size of the management information area 501 from the master boot record partition table 503 to the route directory entry 507 has a length of a multiple of the optimum access unit. Furthermore, the optimum access unit has a length of multiples of the cluster size. Thus, when the file system controller 1701 in the access device 100 accesses the data area 502 in the units of clusters, efficient access can be achieved without access striding over a plurality of optimum access units.

When the access device 100 accesses 8 continuous clusters, access in the optimum access unit in the semiconductor memory card 110 is realized, thereby achieving optimum access to the nonvolatile memory card 115. By formatting the file system management area 118 in this manner, even when the access device 100 accesses a file without taking into account of the properties of the semiconductor memory card 110, substantially optimum access to the semiconductor memory card 110 can be achieved.

As described above, in the present embodiment, the file system interface controller 120 and the low-level IO interface controller 1603 are provided in the semiconductor memory card 110 and the access device 100 can access the semiconductor memory card via any of the interface controllers. Furthermore, the file system interface controller 120 provides the auxiliary function of file system control executed by the file system controller 1701 in the access device 100 and even when the semiconductor memory card 110 is accessed via the two interface controllers, inconsistency in the file system does not occur. Thus, the semiconductor memory card 110 performs a part of file system control in the access device 100, thereby decreasing the load applied to the access device 100.

In the present embodiment, the case where the file system interface controller 120 realizes only format function of the file system is described. A central aim of the present embodiment is that the file system interface controller 120 realizes the auxiliary function of file system control within a range that inconsistency in the file system of the semiconductor memory card 110 does not occur. Accordingly, the file system interface controller 120 may perform not only the format function but also the other auxiliary functions of file system control. Alternatively, the other auxiliary functions of file system control may be performed without including the format function. For example, by providing a command to select the interface controller to be used in the semiconductor memory card 110 and expressly designating and switching the interface controller to be used as necessary by the access device 100, the two interface controllers may be consisted not to be called in parallel.

Although the FAT file system is described as an example in the present embodiment, the other file systems may be used. The card information stored in the card information storage part 119 may be updated depending on use conditions of the semiconductor memory card 120. The memory 116 including the card information storage part 119 may be included in the nonvolatile memory 115 or when the card information is not updated, may be included in the ROM 117.

As described above, Embodiment 3 is characterized by that the nonvolatile memory for storing user data and the like, the card information storage part for storing the card information concerning the physical properties of the semiconductor memory card, the file system interface controller for performing file access suitable for the physical properties of the semiconductor memory card on the basis of the information stored in the card information storage and the low-level IO interface controller for processing the low-level input/output requests to the nonvolatile memory in the semiconductor memory card from the access device outside of the semiconductor memory card are provided in the semiconductor memory card and that the function of the two interface controllers is limited so as not to cause inconsistency in the file system built in the nonvolatile memory by the access from the two interface controllers.

### Embodiment 4

Next, a semiconductor memory card in accordance with Embodiment 4 of the present invention will be described. FIG. 25 is a configuration view of the semiconductor memory card and the access device in Embodiment 4. The configuration shown in FIG. 25 is different from the configuration shown in FIG. 23 in that there is a path for directly calling the card interface controller 106 from the application program 105 in the access device 100 and in that a synchronization controller 2501 is provided in the semiconductor memory card 110.

That is, in Embodiment 4, the file system interface controller 120 and the low-level IO interface controller 1603 are provided in the semiconductor memory card 110 and the access device 100 can access the semiconductor memory card 110 via any of the interface controllers in a similar way of Embodiment 3. The same area on the nonvolatile memory 115 is accessed via the two interface controllers. A difference from Embodiment 3 is that the synchronization controller 2501 is provided in the semiconductor memory card 110 and when the same area is accessed via the two interface controllers, synchronization is done so as not to cause inconsistency in the file system.

The file system interface controller 120 in the present embodiment manages data stored in the nonvolatile memory 115 on the basis of the card information stored in the card information storage part 119 and when the access device 100 inputs the command to require read-only file access processing for OPEN, CLOSE and READ with respect to a file on the nonvolatile memory 115 via the host interface part 111, performs file access processing with respect to the file existing in the nonvolatile memory 115.

When the access device 100 inputs the command to request data writing or data reading processing to or from an arbitrary position in the area in the nonvolatile memory 115 that the file system interface controller uses for data reading via the host interface part 111, data writing or data reading processing to or from the arbitrary position in the area in the nonvolatile memory 115 is performed.

When the low-level IO interface controller 1603 performs data writing processing of management information of the file system existing in the nonvolatile memory 115, the synchronization controller 2501 updates the file system management information that the file system interface controller 120 reads to the RAM in the semiconductor memory card 110. With such configuration, the file system interface controller 120 in the present embodiment has less limitation of the achieved functions as compared to the case where only the format function is achieved as in Embodiment 3.

Subsequently, a function of the synchronization controller 2501 in the present embodiment will be described referring to FIGS. 26 to 28. Here, as an example of the synchronization controller 2501, the case where the file system interface controller 120 achieves a read-only file system function (upper command) and the low-level IO interface controller 1603 achieves the low-level IO function (lower command) will be described. In this case, the access device 100 can control reading and writing with respect to the file system by the file system controller 1701 and access the nonvolatile memory 115 in the semiconductor memory card 110 via the low-level IO interface controller 1603. At the same time, read-only access to the file system built on the nonvolatile memory 115 in the semiconductor memory card 110 via the file system interface controller 120 can be made.

FIG. 26 is a view showing an example of information on the file system read on the RAM 113 of the semiconductor memory card 110 and using these information, the file system interface controller 120 controls the file system. That is, a FAT 2601 and open file information (OFI) 2602, 2603, 2604 and 2605 as information of the opened file read from the nonvolatile memory 115 exist on the RAM 113 and they are used to control the file system.

A cache management table 2606 as information used by the synchronization controller 2501 exists on the RAM 113. FIG. 27 is a view showing information contained in the cache management table 2606. The cache management table 2606 is information showing position on the nonvolatile memory 115 of the information read on the RAM 113 such as FAT 2601 and open file information 2602, 2603, 2604 and 2605. In examples of FIGS. 26 and 27, the FAT 2601 existing in an area of 123 sectors starting from 234th sector on the nonvolatile memory 115 is read on the RAM 113. Two files having the directory entry (DE) at 480th sector and one file having the directory entry at 513rd sector are opened and the open file information 2602, 2603, 2604 and 2605 are cached on the RAM 113.

Next, using FIG. 28, processing of the synchronization controller 2501 in the present embodiment will be described. In the present embodiment, the command issued from the access device 100 to the semiconductor memory card 110 is received by the synchronization controller 2501 once and the upper command and the lower command are distributed to the file system interface controller 120 and the low-level IO interface controller 1603, respectively. FIG. 28 is a view showing the processing procedure of the synchronization controller 2501.

In processing of the synchronization controller 2501, a command is received from the access device 100 (S2801). Next, referring to the received command, it is determined whether or not the command is the invalid command that cannot be recognized itself (S2802). When the command is the invalid command, the error is informed to the access device 100 to finish the processing (S2803). When the command is the recognizable command, it is determined whether or not the command is the RAW_WRITE command explained in FIG. 18 (S2804). When the command is not the RAW_WRITE command, the type of the command is determined (S2805). When the command is the upper command, the file system interface controller 120 is called and when the command is the lower command, the low-level IO interface controller 1603 is called, further, the other processing corresponding to each command is performed and the processing finishes (S2806).

When the command is the RAW_WRITE command, it is determined whether or not the writing position designated by the argument of the command is the same as the FAT 2601 read on the RAM 113 (S2807). In the example in FIGS. 26 and 27, since the FAT 2601 exists in the area of 123 sectors starting from the 234th sector, when data writing of 32 sectors starting from the 256th sector is requested by the RAW_WRITE command, determination is made that the writing position is same.

When determination is made that the writing position is same, the FAT 2601 on the RAM 113 is updated by using data sent from the RAW_WRITE command (S2808). The low-level IO interface controller 1603 is called, the RAW_WRITE command is executed and the processing finishes (S2809). When determination is made that the writing position is not same, it is determined whether it is a writing to the same sector as the sector of the opened directory entry (DE) (S2810).

In the example in FIGS. 26 and 27, since the file having the directory entries existing at the 480th sector and 513rd sector is opened, when data writing to the position of any of the two sectors is requested according to the RAW_WRITE command, the writing position is determined to be same. When determination is made that the writing position is determined not to be same, the procedure proceeds to processing at S2813. When the writing position is determined to be same, referring to data transmitted according to the RAW_WRITE command, it is determined whether or not the data written to the sector including the directory entry changes the directory entry of the opened file (S2811).

In cases where the directory entry changes, when the file size, time stamp and file name are changed, some cases are included, where the directory entry itself is erased and so on. When determination is made that the directory entry does not change, the procedure proceeds to processing at S2813. When determination is made that the directory entry changes, the open file information (OFI) 2602, 2603, 2604 and 2605 on the RAM 113 are updated (S2812).

For example, when the file size, time stamp and file name are changed, each value in the open file information 2602, 2603, 2604 and 2605 is updated. When the directory entry itself is erased, the open file information 2602, 2603, 2604 and 2605 are cleared and updated to be a condition that a file is not opened. Finally, the low-level IO interface controller 1603 is called, the RAW_WRITE command is executed and the processing finishes (S2813).

As described above, the synchronization controller 2501 confirms a writing position in writing access to the semiconductor memory card 110 and in a case of a writing that changes data read on the RAM 113, the data on the RAM 113 is updated at same time of data writing. When the file system interface controller 120 achieves the read-only file system function, it is possible to execute processing so as not to cause inconsistency in the file system by transmitting the file system management information in sync with the writing processing via the low-level IO interface controller 1603.

In the present embodiment, when the file system exists in the semiconductor memory card 111 and the clusters is logically continuous, only one address conversion per one optimum address unit need to be performed and thus, overhead for the address conversion processing can be reduced.

As described above, in the present embodiment, the file system interface controller 120 and the low-level IO interface controller 1603 are provided in the semiconductor memory card 110 and the semiconductor memory card 110 can be accessed via any of the interface controllers. By providing the synchronization controller 2501, synchronization between accesses via the two interface controllers can be achieved. Thus, due to the accesses via the two interface controllers, the possibility of causing inconsistency in the file system can be eliminated and the function of the file system interface controller 120 can be enlarged as compared to that in Embodiment 3.

In the present embodiment, the case where the file system interface controller 120 achieves the read-only file system function is described. A central aim in the present embodiment is that the semiconductor memory card 110 has the two interface controllers and the synchronization controller 2501 achieves synchronization so as not cause inconsistency in the file system when an access is made via each of the interface controllers. Thus, it is an example that the file system interface controller 120 realizes the read-only file system function, and when the synchronization controller 2501 can achieve synchronization so as not cause inconsistency in the file system, the other functions may be realized.

Although the FAT file system is described as an example in the present embodiment, the other file systems may be used. The card information stored in the card information storage part 119 may be updated depending on the use conditions of the semiconductor memory card 120. The memory 116 including the card information storage part 119 may be included in the nonvolatile memory 115 or when the card information is not updated, may be included in the ROM 117.

As described above, Embodiment 4 is characterized by that the nonvolatile memory for storing the user data and the like in the semiconductor memory card, the card information storage part for storing the card information concerning the physical properties of the semiconductor memory card, the file system interface controller for performing file access suitable for the physical properties of the semiconductor memory card on the basis of the information stored in the card information storage, the low-level IO interface controller for processing the low-level input/output requests with respect to the nonvolatile memory in the semiconductor memory card from the access device outside of the semiconductor memory card and the synchronization controller for synchronizing processings to the nonvolatile memory via the file system interface controller and the low-level IO interface controller are provided in the semiconductor memory card.

### Embodiment 5

Next, a semiconductor memory card in Embodiment 5 of the present invention will be described. FIG. 29 is a configuration view of the semiconductor memory card 110 in the present embodiment. The semiconductor memory card 110 shown in FIG. 29 is different from the semiconductor memory card 110 shown in FIG. 1 in that a plurality of file system interface controllers (A, B, C) 2901, 2902 and 2903 is provided in the semiconductor memory card 110 and a file system type flag 2904 exists in the card information storage part 119.

That is, in the present embodiment, types of file systems that the file system interface controllers 2901, 2902 and 2903 manage are each different. The card information storage part 119 stores information on physical properties of the semiconductor memory card including the erase block size of the nonvolatile memory 115 and card information including the file system type flag representing a type of the file system built on the nonvolatile memory 115.

The file system interface controllers 2901 to 2903 manage data stored in the nonvolatile memory 115 as a file on the basis of the card information stored in the card information storage part 119 and performs file access processing including OPEN, CLOSE, READ and WRITE with respect to a file on the nonvolatile memory 115 according to a command input from the access device 100 via the host interface part 111. Among the plurality of the file system interface control parts 2901 to 2903, the file system interface controller corresponding to the file system type flag operates on the semiconductor memory card 115.

It is possible for the access device 100 to access the semiconductor memory card 110 via any of the interface controllers. For this reason, the type of the file system that manages the nonvolatile memory 115 in the semiconductor memory card 110 can be changed depending on usage.

Subsequently, the file system interface controllers 2901 to 2903 in the present embodiment will be described. The file system interface controllers 2901 to 2903 interpret different types of file systems and perform access control. In the present embodiment, in formatting of the file system, a type of the used file system is determined and the file system type flag (simply, a type flag in the figure) 2904 is held in the card information storage part 119. The file system type flag 2904 is information that can uniquely specify the type of the selected file system and the file system interface controllers 2901, 2902 and 2903 to be used. After that, when an access is made to the nonvolatile memory 115 via the interface controllers 2901, 2902 and 2903, referring to the file system type flag 2904, the interface controller to be used is selected from the three interface controllers 2901, 2902 and 2903 to control the file system.

FIG. 30 is a flowchart showing a procedure of selecting the file system interface controllers 2901, 2902 and 2903 in the present embodiment. In processing shown in FIG. 30, first, a command is received from the access device 100 (S3001). Next, referring to the received command, it is determined whether or not the command is the invalid command that cannot be recognized itself (S3002). When the command is the invalid command, the error is informed to the access device 100 and the processing finishes (S3003). When the command is the recognizable command, it is determined whether or not the command is a FORMAT command (S3004). When the command is a command other than the FORMAT command, the procedure proceeds to processing at S3010. When the command is the FORMAT command, it is determined whether an argument of the command is a correct value (S3005).

When the invalid argument is designated, for example, the designated argument cannot be interpreted, it is determined that an error occurs and the error is informed to the access device 100 and the processing finishes (S3006). When the argument is correct, the file system interface controllers 2901, 2902 and 2903 are selected based on the argument (S3007). Here, as to the argument, the type (FAT, UDF, etc.) of the file system to be used is directly designated or a flag that uniquely specifies the interface controller such as the “file system interface controller A” is designated. In this manner, it is possible to select the file system interface controllers 2901, 2902 and 2903 used by the semiconductor memory card 110.

Next, the file system type flag 2904 is set in the card information storage part 119 (S3008). Next, the selected file system interface controllers 2901, 2902 and 2903 are called, format processing is executed and the procedure proceeds to processing at S3014 (S3009). The file system interface controllers 2901, 2902 and 2903 called through this processing format the nonvolatile memory 115 depending on the type of the file system managed by themselves.

On the other hand, when the command is a command other than the FORMAT command in the processing at S3004, it is determined whether or not an argument of the command is a correct value (S3010). When the invalid argument is designated, for example, the designated argument cannot be interpreted, it is determined that the error occurs and the error is informed to the access device 100 and the processing finishes (S3011). When the argument is correct, referring to the file system type flag 2904, the file system interface controllers 2901, 2902 and 2903 to be used are selected (S3012).

Next, the selected file system interface controller 2901, 2902 and 2903 are called and processing of each command is performed (S3013). The file system interface controllers 2901, 2902 and 2903 called through the processing performs processing such as file open and reading of file data depending on the type of the file system managed by themselves. Next, it is determined whether the processing by the file system interface controllers 2901, 2902 and 2903 succeeds (S3014). When the processing fails, an error is informed to the access device 100 and the processing finishes (S3015). When the processing succeeds, completion of processing is informed to the access device 100 and the processing finishes (S3016).

As described above, in the present embodiment, a plurality of file system interface controllers 2901, 2902 and 2903 that manages the different types of file systems are provided in the semiconductor memory card 110 and the access device 100 can access the semiconductor memory card 110 via any of the interface controllers. Thus, the file system suitable for high-rate access to a high-capacity file and the file system suitable for access to many low-capacity files can be prepared. By changing the type of the file system according to usage of the semiconductor memory card 110, the file system suitable for each usage can be used.

In addition, in the present embodiment, the example in which the three types of file system interface controllers 2901, 2902 and 2903 exists in the semiconductor memory card 110 is described. The number of the types is not limited to three and any number of types may be adopted. Furthermore, in the present embodiment, although differences are described based on Embodiment 1, the contents of the invention in the present embodiment may be used in combination with those in the other embodiments and may be consisted including the low-level IO interface controller and the synchronization controller.

Furthermore, in the present embodiment, the configuration in which the file system interface controllers 2901, 2902 and 2903 are included in the ROM 117 is described. However, the file system interface controllers 2901, 2902 and 2903 may be consisted to be updatable being included in the memory 116 or the nonvolatile memory 115. That is, it may be composed so as to add a file system interface controller corresponding to a new type of file system, to update the existing file system interface controller or to delete an unnecessary file system interface controller from the outside of the semiconductor memory card 110.

A file system managed by the file system interface controller may be any file system other than the FAT file system and the UDF file system. The card information stored in the card information storage part 119 may be updated depending on use conditions of the semiconductor memory card 110. The memory 116 including the card information storage part 119 may be included in the nonvolatile memory 115.

As described above, Embodiment 5 is characterized by that the nonvolatile memory for storing user data and the like, the card information storage part for storing the card information concerning the physical properties of the semiconductor memory card and a plurality of file system interface controllers that corresponds to plural types of file systems for performing file access suitable for the physical properties of the semiconductor memory card on the basis of the information stored in the card information storage part 119 are provided in the semiconductor memory card.

Although the semiconductor memory card is described in the above-mentioned embodiments, the present invention is not limited to the card-like semiconductor memory and can be applied to semiconductor memory devices in various shapes.

### INDUSTRIAL APPLICABILITY

The semiconductor memory device of the present invention has the device information storage part for storing information on properties of the semiconductor memory device and the interface controller for performing file access suitable for the properties of the semiconductor memory device on the basis of the information and thus, the access device can achieve optimum file access without taking into accounts of the properties of the semiconductor memory device. Such semiconductor memory device can be used as an information recording mediauch as digital AV equipment, mobile phone terminal, PC and the like. Furthermore, since the semiconductor memory device can realize optimum file access according to the properties of the semiconductor memory device, the device operates especially suitably when it is used as the information recording medium for equipment that records high-quality AV data having high transfer rate.

1. A semiconductor memory device comprising:
a nonvolatile memory that consists of a plurality of sectors, a certain number of continuous sectors of which are grouped as a block of a minimum unit for data erase, and writes or reads data transmitted from an external access device;
a memory controller for controlling erase, writing and reading of data to said nonvolatile memory when a command containing a control signal is input from said access device;
a device information storage part for storing device information concerning physical properties of the semiconductor memory device containing erase block size of said nonvolatile memory; and
a file system interface controller for performing file access processing to said nonvolatile memory on the basis of the device information stored in said device information storage part.

2. The semiconductor memory device according to claim 1, wherein
said file system interface controller manages data stored in said nonvolatile memory as a file and when a command to request file access processing to a file on said nonvolatile memory is input from said access device, performs file access processing to a file existing in said nonvolatile memory.

3. The semiconductor memory device according to claim 1, wherein
said nonvolatile memory has a first area and a second area,
said file system interface controller manages data stored in said first area as a file and when a command to request file access processing to a file in said first area of said nonvolatile memory is input from said access device, performs file access processing to a file existing in said first area of said nonvolatile memory,
said semiconductor memory device further comprises:
a low-level IO interface controller for performing writing or reading processing of the data to said second area of said nonvolatile memory, when a command to request writing or reading processing of the data to said second area of said nonvolatile memory is input from said access device for controlling file systems.

4. The semiconductor memory device according to claim 1, further comprises:
a low-level IO interface controller for performing writing or reading processing of data to an arbitrary position in said nonvolatile memory, when a command to request writing or reading processing of data to an arbitrary position of said nonvolatile memory is input from said access device for controlling file systems,
wherein said nonvolatile memory has a common area controlled by both of said file system interface controller and said low-level IO interface controller;
said file system interface controller performs only format processing of constructing file system so that an access unit may be an optimum access unit on the basis of device information stored in said device information storage part to the common area on said nonvolatile memory; and
file access processing other than the format processing to a file existing in the common area on said nonvolatile memory is executed by said low-level IO interface controller on the basis of the command input from said access device.

5. The semiconductor memory device according to claim 1, wherein
when a command to request read-only file access processing to a file on said nonvolatile memory is input from said access device, said file system interface controller performs file access processing to a file existing in said nonvolatile memory,
said semiconductor memory device further comprises:
a low-level IO interface controller for performing writing or reading processing of data at the arbitrary position in said nonvolatile memory, when a command to request writing or reading processing of data at an arbitrary position in the area in said nonvolatile memory that said file system interface controller for data reading is input from said access device that controls the file system; and
a synchronization controller for updating file system management information read in a temporary storage memory in said semiconductor memory device by said file system interface controller so as not to cause inconsistency, when said low-level 10 interface controller performs data writing processing to management information of the file system existing in said nonvolatile memory.

6. The semiconductor memory device according to claim 1, wherein
said device information storage part stores information on physical properties of the semiconductor memory device including erase block size of said nonvolatile memory and device information including a file system type flag representing a type of the file system built on the nonvolatile memory,
said file system interface controller consists of a plurality of file system interface controllers for managing data stored in said nonvolatile memory on the basis of device information stored in said device information storage part and for performing file access processing to a file on the nonvolatile memory according to a command input from said access device, and
said file system interface controller corresponding to said file system type flag among said plurality of file system interface controllers operates on said semiconductor memory device.

7. The semiconductor memory device according to claim 1, wherein
said file system interface controller determines an access unit to optimally access to said nonvolatile memory on the basis of information containing erase block size stored in said device information storage part, and sets the size of a management information area of a file system as a length of multiples of the optimum access unit when performing format processing of building the file system in an area of said nonvolatile memory.

8. The semiconductor memory device according to claim 1, wherein
said file system interface controller determines an optimum access unit to optimally access to said nonvolatile memory on the basis of information containing erase block side stored in said device information storage part, and uses said optimum access unit as an area allocation unit when recording file data to said semiconductor memory device.

9. The semiconductor memory device according to claim 1, wherein
said file system interface controller determines the optimum access unit to optimally access to said nonvolatile memory on the basis of information containing erase block size stored in said device information storage part, and allocates directory areas so that a plurality of directory areas are included in the same said optimum access unit.

10. The semiconductor memory device according to claim 1, wherein
said file system interface controller is composed of a program stored in a memory as a nonvolatile updatable recording medium, and
said file system interface controller can be replaced, updated or deleted from the outside of said semiconductor memory device.

11. A control method of a semiconductor memory device having a nonvolatile memory that consists of a plurality of sectors, and that a certain number of continuous sectors of which are grouped as a block of a minimum unit for data erase, comprising steps of:
storing device information in advance on physical properties of the semiconductor memory device containing erase block size of said nonvolatile memory in a device information storage part;
accepting a command containing a control signal from an external access device;
performing file access processing to said nonvolatile memory on the basis of the device information stored in said device information storage part by the file system interface controller; and
performing erase, writing and reading of data to said nonvolatile memory on the basis of the accepted command.

12. The control method of the semiconductor memory device according to claim 11, comprising steps of:
managing data stored in said nonvolatile memory as a file by said file system interface controller; and
performing file access processing to a file existing in said nonvolatile memory, when a command to request file access processing to a file on said nonvolatile memory is input from said access device.

13. The control method of the semiconductor memory device according to claim 11, comprising steps of:
determining an access unit to optimally access to said nonvolatile memory on the basis of information containing erase block size stored in said device information storage part by said file system interface controller; and
setting the size of a management information area of a file system as a length of multiples of the optimum access unit when performing format processing of building the file system in an area of said nonvolatile memory.

14. The control method of the semiconductor memory device according to claim 11, comprising steps of:
determining an optimum access unit to optimally access to said nonvolatile memory on the basis of information containing erase block side stored in said device information storage part by said file system interface controller; and
using said optimum access unit as an area allocation unit when recording file data to said semiconductor memory device.

15. The control method of the semiconductor memory device according to claim 11, comprising steps of:
determining the optimum access unit to optimally access to said nonvolatile memory on the basis of information containing erase block size stored in said device information storage part by said file system interface controller; and
allocating directory areas so that a plurality of directory areas are included in the same said optimum access unit.
